(19) United States
(12) Patent Application Publication
(10) Pub. No.: US 2024/0397232 A1
(43) Pub. Date: Nov. 28, 2024

(54) IMAGE SENSOR

(71) Applicant: SAMSUNG ELECTRONICS CO., LTD., SUWON-SI (KR)

(72) Inventors: WONTAK CHOI, SUWON-SI (KR); SIN-HWAN LIM, SUWON-SI (KR)

(21) Appl. No.: 18/394,992

(22) Filed: Dec. 22, 2023

(30) Foreign Application Priority Data
May 24, 2023 (KR) 10-2023-0067115

(51) Int. Cl. H04N 25/772; H04N 25/709; H04N 25/71

(52) U.S. Cl. CPC H04N 25/772; H04N 25/709; H04N 25/745

(57) ABSTRACT

An image sensor includes a pixel array including pixels that output a pixel signal, a ramp signal generator that generates a first ramp signal and a second ramp signal, and an analog-to-digital converter. A first offset voltage level of the first ramp signal rises or falls with a first slope and a second offset voltage level of a second ramp signal rises or falls with a second slope different from the first slope. A starting time at which the first ramp signal rises or falls with the first slope and a starting time at which the second ramp signal rises or falls with the second slope are different. The analog-to-digital converter generates an image signal based on a first comparison result obtained by comparing the pixel signal and the first ramp signal and a second comparison result obtained by comparing the pixel signal and the second ramp signal.

### CROSS-REFERENCE TO RELATED APPLICATIONS

This application claims priority under 35 U.S.C. § 119 to Korean Patent Application No. 10-2023-0067115, filed on May 24, 2023, the disclosure of which is incorporated by reference herein in its entirety.

### TECHNICAL FIELD

Embodiments of the present disclosure relate to an image sensor.

### DISCUSSION OF RELATED ART

An image sensor is a device that captures a two-dimensional or a three-dimensional image of an object. An image sensor creates an image of an object by using a photovoltaic device that reacts depending on an intensity of light reflected from the object.

As the demand for image sensors with improved performance in various fields increases, complementary metal-oxide semiconductor (CMOS) image sensors using unit pixels are becoming more widely used. CMOS image sensors may generally be driven by a correlated double sampling (CDS) method, for example, a method of outputting a difference between a reset signal and an image signal as a digital signal. A ramp signal is used to output the difference between the reset signal and the image signal as a digital signal. In other words, the CMOS image sensor may pick up the difference between the video signal and the reset signal, which may vary according to the intensity of the external light, and convert it into the digital signal according to the slope of the ramp signal to be output.

Recently, to increase a dynamic range of the image sensor, a dual slope gain (DSG) method has been used in which one pixel signal is read by using two ramp signals having different slopes.

### SUMMARY

Embodiments of the present disclosure relate to providing a ramp signal for reading a pixel signal.

According to an embodiment of the present disclosure, an image sensor includes a pixel array including a plurality of pixels configured to output a pixel signal, and a ramp signal generator circuit configured to generate a first ramp signal and a second ramp signal. A first offset voltage level of the first ramp signal rises or falls with a first slope and a second offset voltage level of a second ramp signal rises or falls with a second slope different from the first slope. A starting time at which the first ramp signal rises or falls with the first slope and a starting time at which the second ramp signal rises or falls with the second slope are different.

The image sensor further includes an analog-to-digital converter circuit configured to generate an image signal based on a first comparison result obtained by comparing the pixel signal and the first ramp signal and a second comparison result obtained by comparing the pixel signal and the second ramp signal.

In an embodiment, the image sensor further includes a timing controller circuit configured to generate a first ramp control signal that controls the ramp signal generator circuit to generate the first ramp signal and a second ramp control signal that controls the ramp signal generator circuit to generate the second ramp signal.

In an embodiment, the first ramp control signal includes a first ramp reset signal that controls the starting time of the first ramp signal, and the second ramp control signal includes a second ramp reset signal that controls the starting time of the second ramp signal. The first ramp reset signal is enabled at a different time than the second ramp reset signal.

In an embodiment, the first slope is greater than the second slope, the first ramp reset signal is enabled at a first time, and the second ramp reset signal is enabled at a second time after the first time.

In an embodiment, the first ramp control signal includes a first emphasis activation signal that controls the first offset voltage level, and the second ramp control signal includes a second emphasis activation signal that controls the second offset voltage level. The ramp signal generator circuit includes a first emphasis circuit that operates based on the first emphasis activation signal, and a second emphasis circuit that operates based on the second emphasis activation signal. The first offset voltage level is different from the second offset voltage level.

In an embodiment, the first slope is greater than the second slope, and the first offset voltage level is less than the second offset voltage level.

In an embodiment, the first emphasis circuit includes a plurality of first emphasis current sources that operate in response to the first emphasis activation signal, and the second emphasis circuit includes a plurality of second emphasis current sources that operate in response to the second emphasis activation signal.

In an embodiment, the first ramp control signal includes a first ramp activation signal that controls the first slope, and the second ramp control signal includes a second ramp activation signal that controls the second slope, and the ramp signal generator circuit further includes a first ramp circuit that operates based on the first ramp activation signal, and a second ramp circuit that operates based on the second ramp activation signal.

In an embodiment, the first ramp circuit includes a plurality of first current sources operating in response to the first ramp activation signal, and the second ramp circuit includes a plurality of second current sources operating in response to the second ramp activation signal.

In an embodiment, the first ramp control signal includes a first ramp reset signal that controls the starting time of the first ramp signal and a first emphasis activation signal that controls the first offset voltage level of the first ramp signal. The second ramp control signal includes a second ramp reset signal that controls the starting time of the second ramp signal and a second emphasis activation signal that controls the second offset voltage level of the second ramp signal. The ramp signal generator circuit includes a first emphasis circuit that operates based on the first emphasis activation signal, and a second emphasis circuit that operates based on the second emphasis activation signal. The first ramp reset signal is enabled at a time different from that of the second ramp reset signal, and the first offset voltage level of the first ramp signal is different from the second offset voltage level of the second ramp signal.

In an embodiment, the analog-to-digital converter circuit includes a first comparator that generates the first comparison result by comparing the pixel signal and the first ramp signal, and a second comparator that generates the second comparison result by comparing the pixel signal and the second ramp signal. A first time at which the pixel signal and the first ramp signal have a same value is different from a second time at which the pixel signal and the second ramp signal have a same value.

According to an embodiment of the present disclosure, an operation method of an image sensor includes outputting a pixel signal from a pixel array including a plurality of pixels, generating a first ramp signal having a first slope at a first time based on a first ramp reset signal, generating a second ramp signal having a second slope different from the first slope at a second time different from the first time based on a second ramp reset signal, and generating an image signal based on a first comparison result obtained by comparing the pixel signal and the first ramp signal, and a second comparison result obtained by comparing the pixel signal and the second ramp signal.

In an embodiment, generating the first ramp signal includes generating the first ramp signal having a first offset voltage level based on a first emphasis activation signal, and generating the second ramp signal includes generating the second ramp signal having a second offset voltage level different from the first offset voltage level based on a second emphasis activation signal.

In an embodiment, generating the second ramp signal includes generating the second ramp signal having the second offset voltage level greater than the first slope and less than the first offset voltage level.

In an embodiment, generating the first ramp signal includes controlling a plurality of first current sources to have the first slope based on a first ramp activation signal, and generating the second ramp signal includes controlling a plurality of second current sources to have the second slope based on a second ramp activation signal.

According to an embodiment of the present disclosure, an image sensor includes a pixel array including a plurality of pixels configured to output pixel signal, a first comparator connected to the pixel array and configured to generate a first comparison result obtained by comparing the pixel signal with a first ramp signal that rises or falls with a first slope, a second comparator connected to the pixel array and configured to generate a second comparison result obtained by comparing the pixel signal with a second ramp signal that rises or falls with a second slope different from the first slope, a first counter circuit connected to the first comparator and configured to count the first comparison result based on a first clock signal, and a second counter circuit connected to the second comparator and configured to count the second comparison result based on a second clock signal different from the first clock signal. The first counter circuit and the second counter circuit start counting at different times.

In an embodiment, the first counter circuit generates a first digital signal by counting the first comparison result, and the second counter circuit generates a second digital signal by counting the second comparison result, and the image sensor further includes a timing controller circuit configured to generate a first ramp control signal that generates the first ramp signal and a second ramp control signal that generates the second ramp signal based on the first digital signal and the second digital signal.

In an embodiment, the image sensor further includes a ramp signal generator circuit configured to generate the first ramp signal and the second ramp signal based on the first ramp control signal and the second ramp control signal.

In an embodiment, the first ramp control signal controls a starting time and an offset voltage level of the first ramp signal, and the second ramp control signal controls a starting time and an offset voltage level of the second ramp signal.

In an embodiment, the first comparator and the second comparator share a power source voltage and a ground voltage.

### BRIEF DESCRIPTION OF THE DRAWINGS

The above and other features of the present disclosure will become more apparent by describing in detail embodiments thereof with reference to the accompanying drawings.

FIG. 1 is an example block diagram of an image processing block according to an embodiment.

FIG. 2 is an example block diagram of an image sensor according to an embodiment.

FIG. 3 is a circuit diagram showing a pixel of an image sensor according to an embodiment.

FIG. 4 is a view showing an analog-to-digital converter (ADC) according to an embodiment.

FIG. 5 is a circuit diagram showing a comparison circuit according to an embodiment.

FIG. 6 is a block diagram of a ramp signal generator according to an embodiment.

FIG. 7 is a circuit diagram that exemplarily embodies a ramp signal generator according to FIG. 6.

FIG. 8 is a timing diagram for explaining an operation of a ramp signal generator according to an embodiment.

FIG. 9 is an example block diagram of an image sensor according to an embodiment.

FIG. 10 is a block diagram of a ramp signal generator according to an embodiment.

FIG. 11 is a timing diagram for explaining the operation of the ramp signal generator according to an embodiment.

FIG. 12 is a timing diagram for explaining an operation of a ramp signal generator according to an embodiment.

FIG. 13 is a timing diagram for explaining an operation of a ramp signal generator according to an embodiment.

FIG. 14 is a timing diagram for explaining an operation of a ramp signal generator according to an embodiment.

FIG. 15 is a timing diagram for explaining an operation of a ramp signal generator according to an embodiment.

FIGS. 16-19 are graphs showing a case of reading a pixel signal by using a ramp generating circuit according to an embodiment.

FIG. 20 is a block diagram of an electronic device having a multi-camera module including an image sensor according to an embodiment.

FIG. 21 is a block diagram showing a camera module of FIG. 20 according to an embodiment.

### DETAILED DESCRIPTION OF THE EMBODIMENTS

Embodiments of the present disclosure will be described more fully hereinafter with reference to the accompanying drawings. Like reference numerals may refer to like elements throughout the accompanying drawings.

According to embodiments, in the flowcharts described with reference to the drawings, an order of operations may be changed, several operations may be merged, some operations may be divided, and specific operations may not be performed.

It will be understood that the terms “first,” “second,” “third,” etc. are used herein to distinguish one element from another, and the elements are not limited by these terms. Thus, a “first” element in an embodiment may be described as a “second” element in another embodiment.

It should be understood that descriptions of features or aspects within each embodiment should typically be considered as available for other similar features or aspects in other embodiments, unless the context clearly indicates otherwise.

As used herein, the singular forms “a”, “an” and “the” are intended to include the plural forms as well, unless the context clearly indicates otherwise.

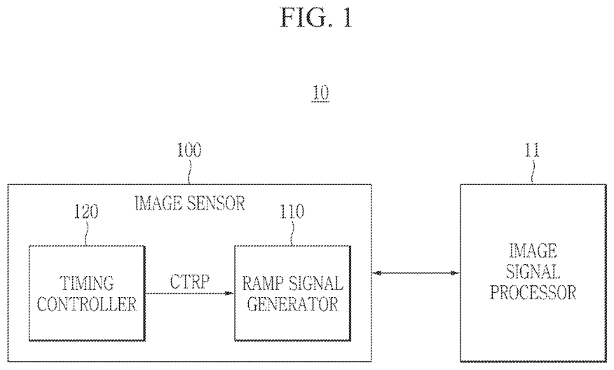

FIG. 1 is an example block diagram of an image processing block according to an embodiment.

Referring to FIG. 1, an image processing block 10 may be implemented as part of various electronic devices such as, for example, a camera, a smartphone, a wearable device, an internet of things (IoT) device, a tablet PC (Personal Computer), a PDA (Personal Digital Assistant), a PMP (Portable Multimedia Player), a navigation device, etc. In addition, the image processing block 10 may be mounted on electronic devices provided as components in, for example, vehicles, furniture, manufacturing facilities, doors, and various measuring devices. The image processing block 10 may detect light reflected from an external object and process image data.

The image processing block 10 may include an image sensor 100 and an image signal processor 11.

The image sensor 100 may operate under the control of the image signal processor 11.

The image sensor 100 may detect light reflected from an external object and convert the detected light into an electrical signal. For example, the image sensor 100 may be implemented as a Complementary Metal Oxide Semiconductor (CMOS) image sensor or the like. The image sensor 100 may include a pixel array. The pixels of the pixel array may generate pixel values by converting light into an electric signal. For example, the image sensor 100 may be a multi-pixel image sensor having a dual pixel structure or a tetra cell structure. The image sensor 100 may provide the generated electrical signal to the image signal processor 11 as image data.

The image sensor 100 may include a timing controller 120 and a ramp signal generator 110. The timing controller 120 may also be referred to as a timing control circuit, and the ramp signal generator 110 may also be referred to as a ramp signal generator circuit.

The ramp signal generator 110 may generate a ramp signal. The ramp signal generator 110 may generate the ramp signal based on a ramp control signal CTRP. The ramp control signal CTRP may include a ramp activation signal for generating the ramp signal, an emphasis activation signal for controlling a voltage level of the ramp signal, and the like. The ramp signal may be a signal that repeatedly includes a waveform that maintains a constant voltage and then rises or falls with a constant slope.

In some embodiments, the ramp signal generator 110 may generate a plurality of ramp signals. The ramp signal generator 110 may generate a plurality of ramp signals having different starting times. The starting time of the ramp signal may be a time that the repeating waveform of the ramp signal starts. For example, the starting time of the ramp signal may be a time at which the rising is started with a certain slope. For example, the starting time of the ramp signal may be a time at which the falling of the ramp signal is started with a certain slope. The ramp signal generator 110 may generate a plurality of ramp signals having

different offset voltage levels. The offset voltage level may be a difference between a constant voltage of the ramp signal and a voltage after the ramp signal increases. For example, when the ramp signal maintains the first voltage and increases with a constant slope to become the second voltage, since the offset voltage level is the value of the second voltage using the first voltage as a reference voltage, it may be a value obtained by subtracting the second voltage value from the first voltage value.

The timing controller 120 may output the ramp control signal CTRP to the ramp signal generator 110. The timing controller 120 may control the ramp signal generator 110.

The image signal processor 11 may communicate with the image sensor 100. The image signal processor 11 may control the operation of the image sensor 100. For example, the image signal processor 11 may control the timing controller 120 to output a signal to the ramp signal generator 110. The image signal processor 11 may receive the image data generated by the image sensor 100. The image signal processor 11 may process the image data. The image signal processor 11 may store the image data in a storage device or output the image data to a display device.

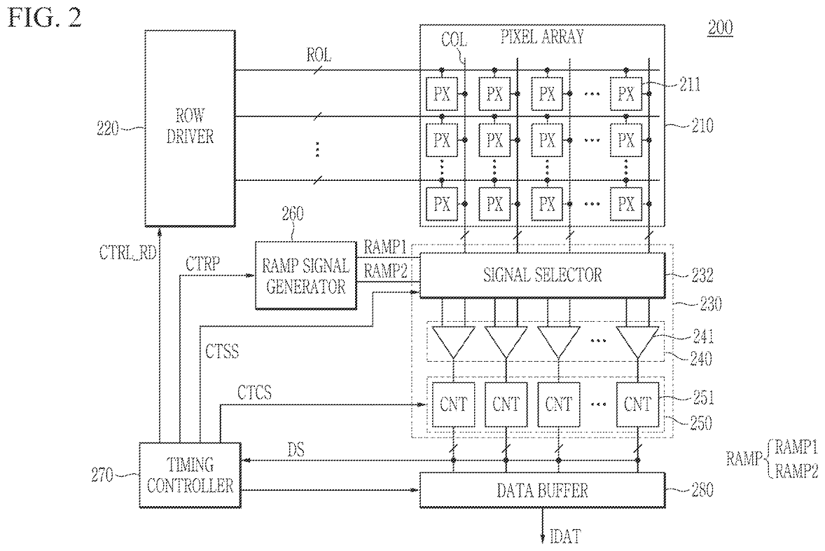

FIG. 2 is an example block diagram of an image sensor according to an embodiment.

Referring to FIG. 2, the image sensor 200 may include a pixel array 210, a row driver 220, an analog-to-digital converter (ADC) circuit 230, a ramp signal generator 260, a timing controller 270, and a data buffer 280.

The pixel array 210 may include a plurality of pixels 211. Each of the plurality of pixels 211 may be arranged in a row direction and a column direction. The pixels positioned on the same column may be connected to the same column line COL. The pixels positioned on the same row may be connected to the same row line ROL.

Each of the plurality of pixels 211 may include at least one light sensing element. For example, the photo-sensing element may include a photodiode, a phototransistor, a port gate or a pinned photodiode. In some embodiments, each of the plurality of pixel 211 may include a plurality of light sensing elements. The plurality of light sensing elements may be stacked on each other.

Each of the plurality of pixels 211 may sense light by using the light sensing element and convert the light into a pixel signal, which is an electrical signal. The pixel signal may be an analog signal corresponding to the intensity or amount of light received from outside of the image sensor 200. Each of the plurality of pixels 211 may detect light of a specific spectrum region. For example, the plurality of pixels 211 may include a red pixel that converts light in a red spectrum region into an electric signal, a green pixel that converts light in a green spectrum region into an electric signal, and a blue pixel that converts light in a blue spectrum region into an electric signal. A color filter that transmits light of a specific spectrum region may be disposed on each of the plurality of pixels 211. The pixel signal may include a reset signal generated according to a reset operation of each of the plurality of pixels 211 and may include an image signal according to a light sensing operation of each of the plurality of pixels 211.

The timing controller 270 may control the operation or the timing of the row driver 220, the ADC circuit 230, and the ramp signal generator 260 by outputting a control signal or a clock signal to each of the row driver 220, the ADC circuit 230, and the ramp signal generator 260.

In some embodiments, the timing controller 270 may control the row driver 220, the signal selector 232, the ramp signal generator 260, and the counter circuit 250 under the control of the image processor 11. The timing controller 270 may output a row control signal CTRL_RD to the row driver 220. The timing controller 270 may output a selection control signal CTSS to the signal selector 232. The timing controller 270 may output the ramp control signal CTRP to the ramp signal generator 260. The timing controller 270 may output a counter control signal CTCS to the counter circuit 250.

The row driver 220 may drive the pixel array 210 in a row unit. For example, the row driver 220 may be connected to the pixel array 210 through the row lines ROL. The row driver 220 may receive the row control signal CTRL_RD generated by the timing controller 270. For example, the row control signal CTRL_RD may be an address signal. The row driver 220 may decode the received row control signal CTRL_RD and select at least one row line among the row lines constituting the pixel array 210 based on the decoded row control signal CTRL_RD. For example, the row driver 220 may generate a row selection signal. The pixel array 210 may output the pixel signal from the row selected by a row selection signal provided from the row driver 220.

The ADC circuit 230 may convert the pixel signal, which is an analog signal input from the pixel array 210, into the digital signal. The ADC circuit 230 may include a signal selector 232, a comparison circuit 240, and a counter circuit 250.

The signal selector 232 may receive ramp signals RAMP1 and RAMP2 from the ramp signal generator 260 and receive the pixel signals from the pixel array 210. The signal selector 232 may operate based on the selection control signal CTSS provided from the timing controller 270. During an image sensing period, the signal selector 232 may output the pixel signals and the ramp signals RAMP1 and RAMP2 to the comparison circuit 240 based on the selection control signal CTSS. For example, the signal selector 232 may select one ramp signal among the received ramp signals RAMP1 and RAMP2 based on the selection control signal CTSS, and output the pixel signal and the selected ramp signal. During the image sensing period, the slopes of the ramp signals RAMP1 and RAMP2 output by the signal selector 232 may be identical to or different from each other.

A method of reading one image with two analog gains for one pixel signal through two ramp signals RAMP1 and RAMP2 including the ramp signals having the different slopes is referred to as a dual slope gain (DSG) method. The image sensor 200 obtains a reduced signal-to-noise ratio (SNR) dip and increased dynamic range (DR) by reducing a quantization noise (QN) for the image signal by reading the pixel signal by applying the DSG method.

The comparison circuit 240 may compare the pixel signal output from the unit pixel connected to any one column line among the column lines COLs constituting the pixel array 210 with one of the ramp signals RAMP1 and RAMP2. The comparison circuit 240 may include a plurality of comparison circuits 241, and each of the plurality of comparison circuits 241 may be connected to at least one corresponding column line among the plurality of column lines COLs through the signal selector 232. Each of the plurality of comparison circuits 241 may be connected to the ramp signal generator 260 through the signal selector 232.

The comparison circuit 241 may receive and compare the pixel signal generated from the pixel array 210 with one of the ramp signals RAMP1 and RAMP2 generated from the ramp signal generator 260, and output a comparison result signal.

In an embodiment, during the image sensing period, the comparison circuit 241 may be connected to one corresponding column line COL through the signal selector 232 to receive the pixel signal and receive one of the ramp signals RAMP1 and RAMP2 from the ramp signal generator 260. For example, the comparison circuit 241 may output a comparison result signal obtained by comparing the pixel signal and the first ramp signal RAMP1.

The comparison circuit 241 may generate the comparison result signal to which a correlated double sampling technique is applied, and may be referred to as a correlated double sampling circuit. The pixel signals output from the plurality of pixel 211 may have a deviation due to pixel-specific characteristics (e.g., Fixed Pattern Noise (FPN), etc.) of each pixel and/or a deviation due to a difference in a logic characteristic for outputting the pixel signals from the pixel 211. To compensate for the deviation between these pixel signals, that a reset component (or a reset signal) and an image component (or an image signal) for each pixel signal are acquired by a double sampling, and the difference between the reset component and the image component is extracted as an effective signal component, may be referred to as the correlated double sampling. The comparison circuit 241 may output a comparison result signal to which the correlated double sampling technique is applied. For example, the comparison circuit 241 may output a comparison result signal that transitions from the first level (e.g., a logic high) to the second level (e.g., a logic low) when the level of the first ramp signal RAMP1 and the level of the pixel signal are the same. A time at which the level of the comparison result signal transitions may be determined according to the level of the pixel signal, the slope of the ramp signal, and the like. The comparison circuit 241 may output the comparison result signal to the counter circuit 250. For example, the comparison circuit 241 may output the signal having logic high during a period in which the voltage level of the ramp signal RAMP1 is higher than the voltage level of the pixel signal. The comparison circuit 241 may output a signal having logic low during a period in which the voltage level of the first ramp signal RAMP1 is lower than the voltage level of the pixel signal.

The counter circuit 250 may include a plurality of counters (CNT) 251. Each of the plurality of counters 251 may be connected to an output terminal of the comparison circuit 241 and may count an output signal of each comparison circuit 241. The counter control signal CTCS may include, for example, a counter clock signal, a counter reset signal for controlling the reset operation of the plurality of counters 251, and an inversion signal for inverting an internal bit of each of the plurality of counters 251. The counter circuit 250 may count the comparison result signal based on the counter clock signal and output the counting result as a digital signal DS.

The counter 251 may include an up/down counter and a bit-wise counter. The bit-wise inversion counter may perform an operation similar to that of the up/down counter. For example, the bit-wise inversion counter may perform a function of performing only an up count and a function of inverting all bits inside the counter to be a 1's complement when a specific signal is input. The bit-wise inversion counter may perform the reset count and then invert the count to convert the count into a 1's complement, that is, a negative value.

In some embodiments, the counter 251 may count the comparison result signal output by the corresponding comparison circuit 241 and output the comparison result signal as a digital signal. The counter 251 may output the digital signal DS to the data buffer 280.

However, the image sensor 100 according to present disclosure is not limited thereto. For example, according to embodiments, the image sensor 100 may further include a counting code generator that generates a counting code under the control of the timing controller 270. The counting code generator may be implemented as a gray code generator, and a plurality of code values having a resolution according to a predetermined number of bits may be generated as a counting code. For example, if a 10-bit code is predetermined, the counting code generator may generate a counting code including 1024 code values that sequentially increase or decrease. In some embodiments, the counter circuit 250 may include a latch circuit and a calculation circuit, and the latch circuit may receive the counting code from the counting code generator and the output signal from the comparison circuit 240, and latch a code value corresponding to the reset signal, for example, a reset value and a code value corresponding to the image signal, for example an image signal value, respectively. The calculation circuit may calculate the reset value and the image signal value to generate an image signal value in which the reset level of the pixel 211 is removed. The counter circuit 250 may output the image signal value from which the reset level is removed as a pixel value.

The ramp signal generator 260 may generate ramp signals RAMP. For example, the ramp signal generator 260 may generate the ramp signals RAMP that linearly increase or decrease during a specific period. That is, the ramp signals RAMP may be signals that increase or decrease according to a predetermined slope. The ramp signals RAMP may include the first ramp signal RAMP1 and the second ramp signal RAMP2.

The ramp signal generator 260 may operate based on the ramp control signal CTRP provided from the timing controller 270.

The ramp control signal CTRP may include a ramp reset signal, a ramp activation signal, and an emphasis activation signal. The ramp reset signal may be a signal for controlling the ramp signal generator 260 to start an operation of generating the ramp signal. For example, the ramp signal generator 260 may start an operation of generating the ramp signal based on the ramp reset signal of an enable level. The ramp activation signal may be a signal for the ramp signal generator 260 to generate the ramp signal in which the slope decreases. The emphasis activation signal may be a signal for the ramp signal generator 260 to control the offset voltage level of the ramp signal. For example, the ramp signal generator 260 may receive a bias signal from an external power supply circuit. The bias signal may be a signal that provides a voltage utilized to perform the operation of the ramp signal generator 260. The ramp signal generator 260 may control the size of the ramp signal based on the bias signal and the emphasis activation signal received from the timing controller 270.

Upon receiving the ramp reset signal of the enable level, the ramp signal generator 260 may generate the ramp signals RAMP based on the ramp activation signal and the emphasis activation signal. For example, the ramp signal generator 260 may start with the offset voltage level corresponding to the emphasis activation signal and the ramp activation signal when the ramp reset signal is activated, and may generate the ramp signals RAMP that decrease with a constant slope when the ramp activation signal is activated.

In an embodiment, the timing controller 270 may control the ramp signal generator 260 based on the digital signal DS received from the counter circuit 250. The timing controller 270 may determine a time difference between the first ramp signal RAMP1 and the second ramp signal RAMP2 by using the digital signal DS output by the counter 251, and generate the ramp control signal CTRP. The timing controller 270 may determine the offset voltage level of the first ramp signal RAMP1 and the offset voltage level of the second ramp signal RAMP2 by using the digital signal DS, and generate the ramp control signal CTRP. In some embodiments, the timing controller 270 may control, based on the digital signal DS read by using the first ramp signal RAMP1 and the second ramp signal RAMP2, a time at which the first and second ramp signals RAMP1 and RAMP2 start, the current size of the current source included in the ramp signal generator 260, the offset of the first and second ramp signals RAMP1 and RAMP2, etc.

The data buffer 280 may temporarily store and amplify the digital signal DS output from the ADC circuit 230 to be output. The data buffer 280 may amplify the digital signal DS to be output as image data IDAT.

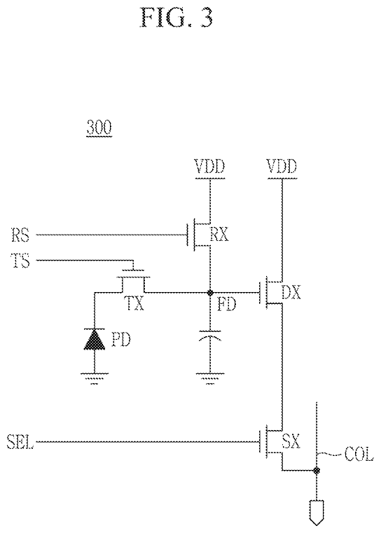

FIG. 3 is a circuit diagram showing a pixel of an image sensor according to an embodiment.

Referring to FIG. 3, the pixel 300 may include a photodiode PD, a transfer transistor TX, a floating diffusion node FD, a reset transistor RX, a driving transistor DX, and a selection transistor SX. The photodiode PD may be replaced by other photovoltaic devices according to some embodiments.

The photodiode PD generates a light charge that varies depending on the intensity of incident light. The transmission transistor TX may transmit the light charge to the floating diffusion node FD according to the transmission control signal TS output from the row driver (220 in FIG. 2).

According to the potential according to the photocharge accumulated in the floating diffusion node FD, the driving transistor DX may amplify and transfer the photocharge to the selection transistor SX. A conversion gain may be varied according to the capacitance of the floating diffusion node FD. For example, when the capacitance increases, the conversion gain may decrease, and when the capacitance decreases, the conversion gain may increase. The pixel 300 may operate a plurality of conversion gain modes including a low conversion gain (LCG) mode with a high capacitance of the floating diffusion node FD or a high conversion gain (HCG) mode with a low capacitance of the floating diffusion node FD. Even if the charge accumulated in the floating diffusion node FD is the same, the voltage of the floating diffusion node FD in the HCG mode may be higher than the voltage of the floating diffusion node FD in the LCG mode.

The drain of the selection transistor SX may be connected to the source of the driving transistor DX, and output the pixel signal PXS to the column line COL connected to the pixel 300 according to the selection signal SEL output from the row driver 220. The reset transistor RX may reset the floating diffusion node FD to the power source voltage VDD level according to the reset control signal RS provided from the row driver 220.

In FIG. 3, the pixel 300 is shown with a 4T (4-transistor) structure including one photodiode PD and four transistors TX, RX, DX, and SX, but each of the plurality of pixels 300 included in the image sensor according to present disclosure is not limited to the structure of FIG. 3. In some embodiments, the pixel 300 may include a plurality of photodiode PDs and a transmission transistor TX connected to the plurality of photodiodes PD. In some embodiments, the pixel 300 may be a pixel of a 3-transistor 3T) including three transistors selected among the transmission transistor TX, the reset transistor RX, the driving transistor DX, and the selection transistor SX. In some embodiments, the pixel 300 may include a plurality of floating diffusion nodes FD.

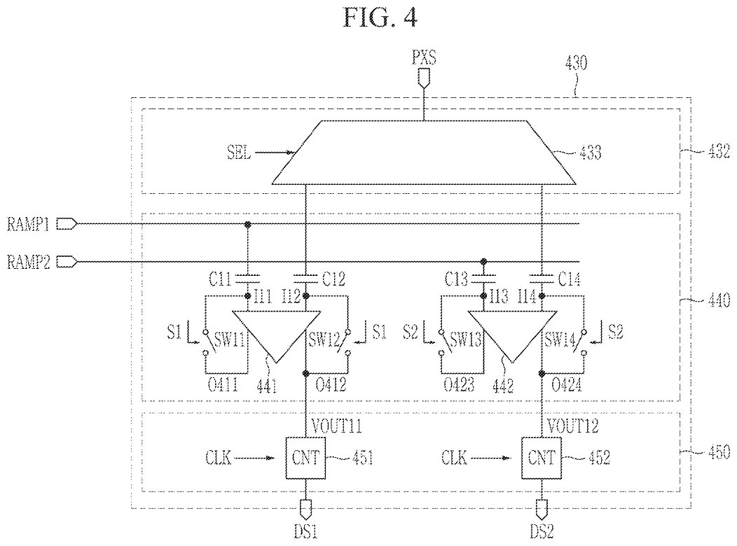

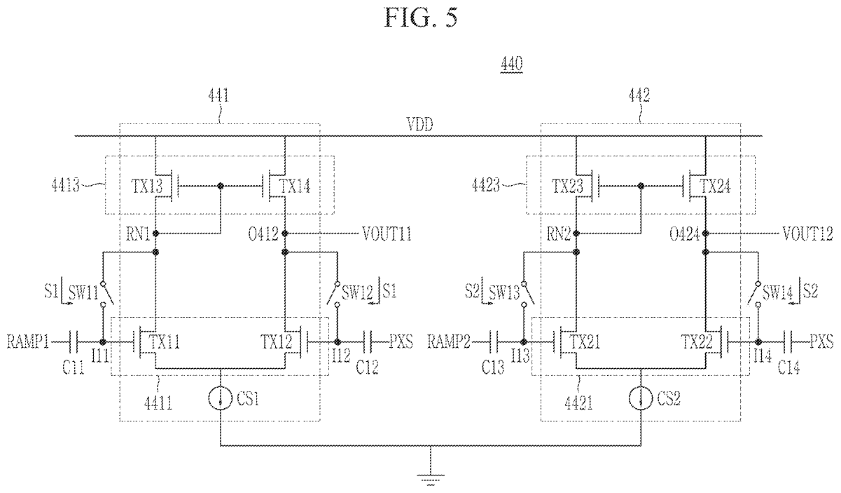

FIG. 4 is a view showing an ADC according to an embodiment. FIG. 5 is a view showing a comparison circuit according to an embodiment.

Referring to FIG. 4, an ADC 400 may include a signal selector 432, a comparison circuit 440, and a counter circuit 450.

An output terminal of the signal selector 432 may be connected to an input terminal of the comparison circuit 440, and an output terminal of the comparison circuit 440 may be connected to an input terminal of the counter circuit 450. Although it is shown that the pixel signal PXS provided from one column line is applied to the input terminal of the signal selector 432 in FIG. 4, in embodiments, a plurality of pixel signal PXS provided from a plurality of column lines may be applied to an input terminal of the signal selector 432.

In an embodiment, the signal selector 432 may receive the selection signal SEL as a selection control signal (CTSS in FIG. 2) from a timing controller (270 in FIG. 2). The signal selector 432 may include a demultiplexer 433. The demultiplexer 433 may receive the pixel signal PXS and output the pixel signal PXS to the comparison circuit 440 based on the selection signal SEL.

The comparison circuit 440 may include a first comparator 441, a second comparator 442, capacitors C11, C12, C13, and C14, and switches SW11, SW12, SW13, and SW14. The first comparator 441 and the second comparator 442 may include differential amplifiers. For example, the first comparator 441 and the second comparator 442 may be implemented as a differential amplifier such as an operational transconductance amplifier (OTA) or an operational amplifier. The first comparator 441 may also be referred to herein as a first comparator circuit, and the second comparator 442 may also be referred to herein as a second comparator circuit.

The first ramp signal RAMP1 may be input to the first input terminal I11 of the first comparator 441 through the capacitor C11, and the pixel signal PXS output from the demultiplexer 433 may be input to the second input terminal 112 of the first comparator 441 through the capacitor C12. The first comparator 441 may compare two signals input to the first input terminal I11 and the second input terminal 112, that is, the pixel signal PXS and the first ramp signal RAMP1, and output the comparison result as a first output signal VOUT11 through the second output terminal O412. The first output terminal O411 and the first input terminal I11 may be connected through the switch SW11, and the second output terminal O412 and second input terminal 112 may be connected through the switch SW12.

The first comparator 441 and the second comparator 442 may be initialized in

response to auto-zero signals S1 and S2 before the comparison operation is performed. For example, in response to the auto zero signals S1 and S2 of the enable level, the first comparator 441 and the second comparator 442 may be initialized, respectively. The first comparator 441 and the second comparator 442 may remove a reset noise of the pixel signal PXS, an internal offset of the first comparator 441 and the second comparator 442, and an offset voltage according to a conversion mode change of the pixel PX by performing the auto zero operation.

Referring to FIG. 5, the first comparator 441 and the second comparator 442 may together share the same power source voltage VDD and ground voltage.

For example, the first comparator 441 may include an input section 4411 connected to the first input terminal I11 and the second input terminal 112, an output section 4413 outputting a first output signal VOUT11, and a current source CS1.

The input section 4411 may include a first transistor TX11 and a second transistor TX12. One terminal of each of the first transistor TX11 and the second transistor TX12 may be connected to the current source CS1. The current source CS1 may provide a bias current that determines the operating point of the first comparator 441. The other terminal of the current source CS1 may be connected to a ground voltage. In some embodiments, the first transistor TX11 and the second transistor TX12 may be n-type metal-oxide semiconductor (NMOS) transistors.

One terminal of the capacitor C11 may be connected to the gate terminal of the first transistor TX11, that is, the first input terminal 111. A first ramp signal RAMP1 is applied to the other terminal of the capacitor C11, and the capacitor C11 DC blocks the first ramp signal RAMP1 to provide an AC signal of the first ramp signal RAMP1 to the first transistor TX11. The capacitor C11 may be used to compensate for the offset of the comparator 441 and the level change of the first ramp signal RAMP1.

One terminal of the capacitor C12 may be connected to the gate terminal of the second transistor TX12, that is, the second input terminal 112. The pixel signal PXS may be applied to the other terminal of capacitor C12, and the capacitor C12 may DC-block the pixel signal PXS, and sample and hold the AC signal of the pixel signal PXS to be provided to the second transistor TX12. The capacitor C12 may be used to compensate for the offset of the comparator 441 and the reset level change of the pixel signal PXS.

The output section 4413 may be implemented as a current mirror circuit including a third transistor TX13 and a fourth transistor TX14. In some embodiments, the third transistor TX13 and the fourth transistor TX14 may be p-type metal-oxide semiconductor (PMOS) transistors.

A power source voltage VDD may be applied to one terminal of the third transistor TX13 and the fourth transistor TX14. The other terminal of third transistor TX13 may be connected to comparison node RN1. The other terminal of the fourth transistor TX14 may be connected to the second output terminal O412. The gate terminals of the third transistor TX13 and the fourth transistor TX14 may be connected to the comparison node RN1. In some embodiments, the comparison node RN1 may be the first output terminal O411 of FIG. 4.

Although it is shown in FIG. 5 that the gate terminals of the third transistor TX13 and fourth transistor TX14 are connected to the comparison node RN1, embodiments are not limited thereto. For example, the gate terminals of the third transistor TX13 and the fourth transistor TX14 may be connected to the second output terminal O412 according to embodiments.

The first switch SW11 may be connected between the first input terminal I11 and the comparison node RN1, and turned on or turned off in response to the auto zero signal S1. The first switch SW11 may be turned on in response to the enable level of the auto zero signal S1, and then the gate of the first transistor TX11 may be connected to the comparison node RN1.

The second switch SW12 may be connected between the second input terminal 112 and the second output terminal O412, and turned on or turned off in response to the auto zero signal S1. The second switch SW12 may be turned on in response to the enable level of the auto zero signal S1, and connect the second input terminal 112 and the second output terminal O412. Accordingly, the second input terminal 112 and the second output terminal O412 are connected to each other so that the voltage levels of the two nodes may be the same.

Referring to FIG. 4, the second ramp signal RAMP2 may be input to the first input terminal 113 of the second comparator 442 through the capacitor C13, and the pixel signal PXS output from the demultiplexer 433 may be input to the second input terminal 114 of the second comparator 442 through the capacitor C14. The second comparator 442 may compare two signals input to the first input terminal 113 and the second input terminal 114, that is, the pixel signal PXS and the second ramp signal RAMP2, and output the comparison result through the second output terminal O424 as a second output signal VOUT12. The first output terminal O423 and the first input terminal 113 may be connected through the switch SW13, and the second output terminal O424 and the second input terminal 114 may be connected through the switch SW14. In some embodiments, the first ramp signal RAMP1 and the second ramp signal RAMP2 may have different slopes.

Referring to FIG. 5, the second comparator 442 may include an input section 4421 connected to the first input terminal 113 and the second input terminal 114, an output section 4423 outputting the second output signal VOUT12, and a current source CS2.

The input section 4421 may include a first transistor TX21 and a second transistor TX22. One terminal of each of first transistor TX21 and second transistor TX22 may be connected to current source CS2. The current source CS2 may provide a bias current that determines the operating point of the second comparator 442. The other terminal of the current source CS2 may be connected to a ground voltage. In some embodiments, the first transistor TX21 and the second transistor TX22 may be NMOS transistors.

One terminal of the capacitor C13 may be connected to the gate terminal of the first transistor TX21, that is, the first input terminal 113. The second ramp signal RAMP2 is applied to the other terminal of the capacitor C13, and the capacitor C13 DC blocks the second ramp signal RAMP2 to provide the AC signal of the second ramp signal RAMP2 to the first transistor TX21. The capacitor C13 may be used to compensate for the offset of the comparator 442 and the level change of the second ramp signal RAMP2.

One terminal of the capacitor C14 may be connected to the gate terminal of the second transistor TX22, that is, the second input terminal 114. The pixel signal PXS is applied to the other terminal of the capacitor C14, and the capacitor C14 may DC-block the pixel signal PXS, and sample and hold the AC signal of the pixel signal PXS to be provided to the second transistor TX22. The capacitor C14 may be used to compensate for the offset of the comparator 442 and the reset level change of the pixel signal PXS.

The output section 4423 may be implemented as a current mirror circuit including a third transistor TX23 and a fourth transistor TX24. In some embodiments, the third transistor TX23 and the fourth transistor TX24 may be PMOS transistors.

The power source voltage VDD may be applied to one terminal of the third transistor TX23 and the fourth transistor TX24. The other terminal of the third transistor TX23 may be connected to the comparison node RN2, and the other terminal of fourth transistor TX24 may be connected to the second output terminal O424. In some embodiments, the comparison node RN2 may be the first output terminal O423 of FIG. 4. The gate terminals of the third transistor TX23 and the fourth transistor TX24 may be connected to the comparison node RN2. On the other hand, although it is shown in FIG. 5®that the gate terminals of the third transistor TX23 and the fourth transistor TX24 are connected to the comparison node RN2, embodiments are not limited thereto. For example, the gate terminal of the third transistor TX23 and the fourth transistor TX24 may be connected to the output terminal O424 according to some embodiments.

The third switch SW13 may be connected between the third input terminal 113 and the comparison node RN2, and may be turned on or turned off in response to the auto zero signal S2. The third switch SW13 may be turned on in response to the enable level of the auto zero signal S2 to connect the gate of the first transistor TX21 to the comparison node RN2. The fourth switch SW14 may be connected between the fourth input terminal 114

and the second output terminal O424, and turned on or turned off in response to the auto zero signal S2. The fourth switch SW14 may be turned on in response to the enable level of the auto zero signal S2 to connect the fourth input terminal 114 to the second output terminal O424. Accordingly, the fourth input terminal 114 and the second output terminal O424 are connected to each other so that the voltage levels of two nodes can be the same.

Although it is shown in FIG. 5 that the first comparator 441 is composed of the current source CS1, the input section 4411, and the output section 4413, and the second comparator 442 is composed of the current source CS2, the input section 4421, and the output section 4423, embodiments are not limited thereto. For example, circuits (e.g., an OTA circuit, a buffer, an inverter, an amplifier, etc.) connected to the output sections 4413 and 4423 of the first comparator 441 and second comparator 442 may be further included according to some embodiments.

The counter circuit 450 may include a counter 451 connected to the second output terminal O412 of the first comparator 441 and a counter 452 connected to the second output terminal O424 of the second comparator 442. Each of the counter 451 and the counter 542 may also be referred to herein as a counter circuit. The counter circuit 450 may receive a counting clock signal CLK from the timing controller (270 in FIG. 2) as a counting control signal (CTCS in FIG. 2). The counter 451 may count the comparison result signal, that is, an output signal VOUT11 of the first comparator 441, based on the counting clock signal CLK, and output the counting result as a digital signal DS1. In addition, the counter 452 may count the comparison result signal, that is, an output signal VOUT12 of the second comparator 442, based on the counting clock signal CLK, and output the counting result as a digital signal DS2. For example, when the output signal VOUT11 to the counter 451 and the output signal VOUT12 to the counter 452 are input at different times, the time at which the counter 451 starts counting and the time at which the counter 452 starts counting may be different. The counter circuit 450 may transmit the digital signals DS1 and DS2 to the data buffer (280 in FIG. 2).

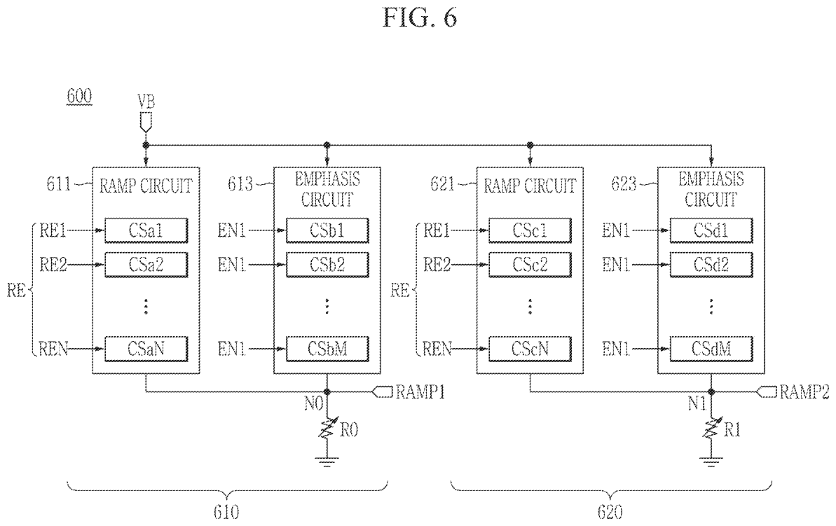

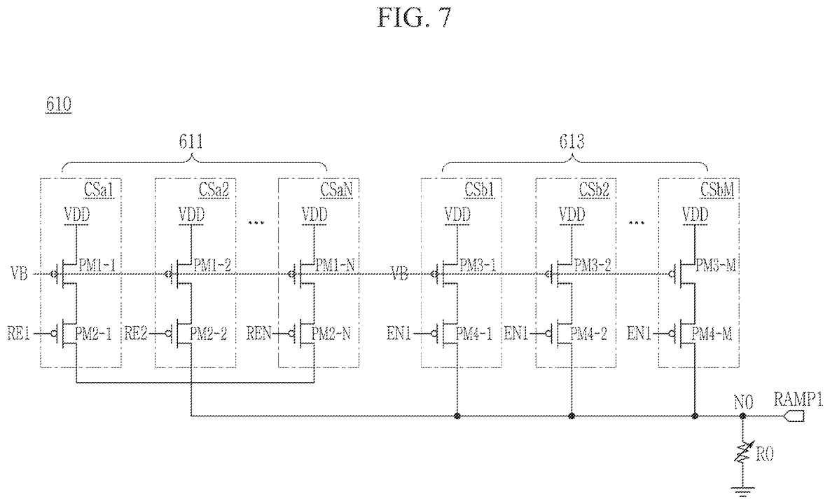

FIG. 6 is a block diagram of a ramp signal generator according to an embodiment. FIG. 7 is a circuit diagram showing a ramp signal generator according to FIG. 6 as an example.

Referring to FIG. 6, the ramp signal generator 600 may include a first ramp generating circuit 610 and a second ramp generating circuit 620. The first ramp generating circuit 610 may generate the first ramp signal RAMP1, and the second ramp generating circuit 620 may generate the second ramp signal RAMP2.

In some embodiments, the first ramp generating circuit 610 may include a ramp circuit 611, an emphasis circuit 613, and an output resistor R0.

The ramp circuit 611 may generate a first ramp signal RAMP1 based on the bias signal VB and the ramp activation signal RE during the ramp period. The ramp period may include a reset period and a sensing period. The reset period may be a period in which the voltage level of the first ramp signal RAMP1 does not decrease. The sensing period may be a period in which the voltage level of the first ramp signal RAMP1 linearly decreases. The first ramp signal RAMP1 may be a signal that repeatedly includes the reset period and the sensing period.

The ramp circuit 611 may receive the bias signal VB from a power supply circuit. The ramp circuit 611 may receive the ramp activation signal RE as the ramp control signal CTRP from the timing controller (270 in FIG. 2). The ramp activation signal RE may include a plurality of ramp activation signals RE1 to REN.

The ramp circuit 611 may include a plurality of current sources cSa1 to cSaN. In some embodiments, each of the plurality of current sources cSa1 to cSaN may operate in response to each of the plurality of ramp activation signals RE1 to REN. For example, the first current source cSa1 may generate the first ramp signal RAMP1 in response to the first ramp activation signal RE1, the second current source cSa2 may generate the first ramp signal RAMP1 in response to the second ramp activation signal RE2, and the N-th current source cSaN may generate the first ramp signal RAMP1 in response to the N-th ramp activation signal REN. For example, first current source cSa1 may be activated in response to the first ramp activation signal RE1, which is a disable level. The first current source cSa1 may be deactivated in response to the first ramp activation signal RE1 that is a disable level. In some embodiments, the disable level may be a logic high level, and the enable level may be a logic low level.

For example, as shown in FIG. 7, each of a plurality of current sources cSa1 to cSaN may include a plurality of transistors. In an embodiment, first current source cSa1 may include first and second PMOS transistors PM1-1 and PM2-1. The first and second PMOS transistors PM1-1 and PM2-1 may be connected in series between a power node that receives the power source voltage VDD and an output node NO that outputs the first ramp signal RAMP1. The first PMOS transistor PM1-1 may operate in response to the bias signal VB. The second PMOS transistor PM2-1 may operate in response to the first ramp activation signal RE1.

The second current source cSa2 to the N-th current source cSaN may be implemented similarly to the first current source cSa1. For example, the second current source cSa2 may include a first PMOS transistor PM1-2 that operates in response to the bias signal VB and a second PMOS transistor PM2-2 that operates in response to the second ramp activation signal RE2. The N-th current source cSaN may include a first PMOS transistor PM1-N that operates in response to the bias signal VB, and a second PMOS transistor PM2-N that operates in response to the N-th ramp activation signal REN.

The plurality of current sources cSa1 to CsaN may be sequentially turned off when the first ramp signal RAMP1 falls with a predetermined slope in advance, and may be sequentially turned on when the first ramp signal RAMP1 rises with a predetermined slope in advance.

In some embodiments, at the beginning of the operation of the ramp signal generator 600, all of the plurality of current sources cSa1 to cSaN may be simultaneously turned on. Next, in the sensing period, in response to the ramp activation signal RE1, the current source cSa1 may be turned off, in response to the ramp activation signal RE2, the current source cSa2 may be additionally turned off, and in response to the ramp activation signal REN, the current source cSaN may be additionally turned off. Accordingly, in the sensing period, the first ramp signal RAMP1 may be lowered to a constant slope. When all current sources cSa1 to cSaN are turned off, the first ramp signal RAMP1 may have the lowest voltage level.

Subsequently, when the first ramp signal RAMP1 rises with the constant slope, the current source cSa1 may be turned on in response to the ramp activation signal RE1, and the current source cSa2 may be additionally turned on in response to the ramp activation signal RE2. In response to the ramp activation signal REN, the current source cSaN may be additionally turned on. When all of the current sources cSa1 to cSaN are turned on, the first ramp signal RAMP1 may have the highest voltage level.

In an embodiment, a plurality of current sources cSa1 to cSaN may be simultaneously turned on or turned off in plurality to generate ramp signals with different slopes.

Referring again to FIG. 6, the emphasis circuit 613 may be connected to the ramp circuit 611 through the output node N0. The output node N0 may be a node that outputs the first ramp signal RAMP1. The emphasis circuit 613 may receive the bias signal VB from the power supply circuit. The emphasis circuit 613 may receive the first emphasis activation signal EN1 from the timing controller 270. The emphasis circuit 613 may include a plurality of emphasis current sources CSb1 to CSbM. Each of the plurality of emphasis current sources CSb1 to CSbM may operate in response to the first emphasis activation signal EN1. Each of the plurality of emphasis current sources CSb1 to CSbM may receive the first emphasis activation signal EN1 from the timing controller 270. Each of the plurality of emphasis current sources CSb1 to CSbM may control the voltage level of the first ramp signal RAMP1 during the reset period and sensing period based on the bias signal VB and the first emphasis activation signal EN1. For example, the first to M-th emphasis current sources CSb1 to CSbM can be activated in response to the first emphasis activation signal EN1, which is an enable level. The first to M-th emphasis current sources CSb1 to CSbM may be deactivated in response to the first emphasis activation signal EN1, which is a disable level. In some embodiments, the enable level may be a logic low level, and the disable level may be a logic high level.

The voltage level of the first ramp signal RAMP1 may correspond to the number of the plurality of emphasis current sources CSb1 to CSbM. For example, as the number of the plurality of current sources CSb1 to CSbM included in the emphasis circuit 613 increases, the voltage level of the first ramp signal RAMP1 may increase.

In some embodiments, the voltage level of the first emphasis activation signal EN1 may be an enable level during the reset period and the sensing period. In some embodiments, the voltage level of the first emphasis activation signal ENI may be a disable level during the reset period, and may be changed from the disable level to the enable level at the start of the sensing period to be the enable level during the sensing period.

In some embodiments, the number of the plurality of current sources cSa1 to cSaN and the number of the plurality of emphasis current sources CSb1 to CSbM may be different. For example, the ramp circuit 611 may include 100 current sources cSa1-cSa100, and the emphasis circuit 613 may include 200 emphasis current sources CSb1-CSb200 in an embodiment.

For example, as shown in FIG. 7, each of the plurality of emphasis current sources CSb1 to CSbM may include a plurality of transistors. In an embodiment, the first emphasis current source CSb1 may include third and fourth PMOS transistors PM3-1 and PM4-1. The third and fourth PMOS transistors PM3-1 and PM4-1 may be connected in series between the power node and the output node N0. The third PMOS transistor PM3-1 may operate in response to the bias signal VB. The fourth PMOS transistor PM4-1 may operate in response to the first emphasis activation signal EN1. For example, the third PMOS transistor PM3 may be turned on in response to the enable bias signal VB, and the fourth PMOS transistor PM4 may be turned on in response to the enable first emphasis activation signal EN1.

The second emphasis current source CSb2 to the M-th emphasis current source CSbM may be implemented similarly to the first emphasis current source CSb1. For example, the second emphasis current source CSb2 may include a third PMOS transistor PM3-2 that operates in response to the bias signal VB and a fourth PMOS transistor PM4-2 that operates in response to the first emphasis activation signal EN1. The N-th emphasis current source cSaN may include a third PMOS transistor PM3-M that operates in response to the bias signal VB and a fourth PMOS transistor PM4-M that operates in response to the first emphasis activation signal EN1.

As all of the gate node of the third PMOS transistors PM3-1 to PM3-M and the gate node of the plurality of first PMOS transistor PM1-1, PM1-2, . . . , PM1-N receive the bias signal VB, the plurality of first PMOS transistor PM1-1, PM1-2, . . . , PM1-N and the third PMOS transistors PM3-1 to PM3-M may operate in a current mirror circuit. That is, the magnitude of the current flowing to the third PMOS transistors PM3-1 to PM3-M may be determined based on the magnitude of the current flowing to the plurality of first PMOS transistor PM1-1, PM1-2, . . . , PM1-N. Accordingly, the emphasis circuit 613 may generate a signal having the same current magnitude.

For example, a plurality of emphasis current sources CSb1 to CSbM may be turned on during the reset period. In response to the first emphasis activation signal EN1, a plurality of emphasis current sources CSb1 to CSbM may be turned on, and all current sources cSa1 to cSaN in the ramp circuit 611 may be turned on. The voltage level of the first ramp signal RAMP1 during the reset period may be based on a plurality of current sources cSa1 to cSaN and a plurality of emphasis current sources CSb1 to CSbM in the ramp circuit 611.

Referring to FIG. 7, although it is shown that the ramp generating circuit 611 includes the plurality of emphasis current sources CSb1 to CSbM, the present disclosure is not limited thereto. For example, according to embodiments, the ramp generating circuit 710 may include one emphasis current source. The ramp generating circuit 710 may control the magnitude of the offset voltage level of the first ramp signal RAMP1 according to the number of emphasis current sources, e.g., the voltage level of the first ramp signal RAMP1 during the ramp period. Alternatively, the timing controller 270 may control the offset of the first ramp signal RAMP1 by simultaneously turning on some current sources among the plurality of current sources cSa1 to cSaN.

According to the power source voltage VDD received by the ramp circuit 611 and the emphasis circuit 613, the emphasis circuit 613 and the ramp circuit 611 may generate signals having different current magnitudes.

In FIG. 7, although it is shown that the ramp circuit 611 and the emphasis circuit 613 are implemented by the PMOS transistor, the present disclosure is not limited thereto. For example, according to embodiments, the ramp circuit 611 and the emphasis circuit 613 may be implemented by NMOS transistors.

The output resistor R0 may be connected to the ramp circuit 611 and the emphasis circuit 613 through the output node N0. The output resistor R0 may be connected between the output node N0 and the ground node that receives a ground power. The output resistor R0 may be a variable resistor. In some embodiments, the voltage level of the first ramp signal RAMP1 may be proportional to the magnitude of the output resistor R0. In some embodiments, the timing controller 270 may adjust the gain of the first ramp signal RAMP1 by changing the resistance value of the variable resistor R0. For example, as the value of the variable resistor R0 increases, the amount of change in the first ramp signal RAMP1 that changes as a plurality of current sources cSa1 to cSaN is turned on or off may increase.

Referring again to FIG. 6, the second ramp generating circuit 620 may include a ramp circuit 621, an emphasis circuit 623, and an output resistor R1.

The ramp circuit 621 may generate a second ramp signal RAMP2 based on the bias signal VB and the ramp activation signal RE during the ramp period. The ramp period may include a reset period and a sensing period. The reset period may be a period in which the voltage level of the second ramp signal RAMP2 does not decrease. The sensing period may be a period in which the voltage level of the second ramp signal RAMP2 linearly decreases. The second ramp signal RAMP2 may be a signal that repeatedly includes the reset period and the sensing period.

The ramp circuit 621 may receive the bias signal VB from a power supply circuit. The ramp circuit 621 may receive the ramp activation signal RE as the ramp control signal CTRP from the timing controller (270 in FIG. 2). The ramp activation signal RE may include a plurality of ramp activation signals RE1 to REN.

The ramp circuit 621 may include a plurality of current sources CSc1-CScN. Each of the plurality of current sources CSc1 to CScN may operate in response to the bias signal VB. Each of the plurality of current sources CSc1 to CScN may operate in response to a corresponding one of the plurality of ramp activation signals RE1 to REN. For example, the first current source CSc1 may generate the second ramp signal RAMP2 in response to the first ramp activation signal RE1, the second current source CSc2 may generate the second ramp signal RAMP2 in response to the second ramp activation signal RE2, and the N-th current source CScN may generate the second ramp signal RAMP2 in response to the N-th ramp activation signal REN. For example, the first current source CSc1 may be activated in response to the first ramp activation signal RE1, which is a disable level. The first current source CSc1 may be deactivated in response to the first ramp activation signal RE1, which is a disable level. In some embodiments, the disable level may be a logic high level, and the enable level may be a logic low level.

The emphasis circuit 623 may be connected to the ramp circuit 621 through the output node N1. The output node N1 may be a node that outputs the second ramp signal RAMP2. The emphasis circuit 623 may receive the bias signal VB from the power supply circuit. The emphasis circuit 623 may receive the first emphasis activation signal EN1 from the timing controller 270. The emphasis circuit 623 may control the voltage level of the second ramp signal RAMP2 during the reset period and the sensing period based on the bias signal VB and the first emphasis activation signal EN1.

The emphasis circuit 623 may include a plurality of emphasis current sources CSd1 to CSdM. Each of the plurality of emphasis current sources CSd1 to CSdM may operate in response to the first emphasis activation signal EN1. Each of the plurality of emphasis current sources CSd1 to CSdM may receive the first emphasis activation signal EN1 from the timing controller 270. Each of the plurality of emphasis current sources CSd1 to CSdM may control the voltage level of the second ramp signal RAMP2 during the reset period and the sensing period based on the bias signal VB and the first emphasis activation signal EN1. For example, the first to M-th emphasis current sources CSd1 to CSdM may be activated in response to the first emphasis activation signal EN1, which is an enable level. The first to M-th emphasis current sources CSd1 to CSdM may be deactivated in response to the first emphasis activation signal EN1, that is a disable level. In some embodiments, the enable level may be logic low level, and the disable level may be logic high level.

The voltage level of the second ramp signal RAMP2 may correspond to the number of the plurality of emphasis current sources CSd1 to CSdM. For example, as the number of the plurality of current sources CSd1 to CSdM included in the emphasis circuit 623 increases, the voltage level of the second ramp signal RAMP2 may increase.

In some embodiment, the plurality of current sources CSc1 to CScN and the plurality of emphasis current sources CSd1 to CSdM may have different numbers. For example, the ramp circuit 621 may include the 100 current sources CSc1-CSc100, and the emphasis circuit 623 may include the 200 emphasis current sources CSd1 to CSd200.

The output resistor R1 may be connected to the ramp circuit 621 and the emphasis circuit 623 through the output node N1. The output resistor R1 may be connected between the output node N1 and the ground node that receives the ground power. The output resistor R1 may be a variable resistor. In an embodiment, the voltage level of the second ramp signal RAMP2 may be proportional to the magnitude of the output resistor R1.

In FIG. 7, the ramp circuit 621 and the emphasis circuit 623 are all illustrated as being implemented with PMOS transistors. However, the present disclosure is not limited thereto. For example, according to embodiments, the ramp circuit 621 and the emphasis circuit 623 may be implemented with NMOS transistors.

The slopes of the first ramp signal RAMP1 generated by the first ramp generating circuit 610 and the second ramp signal RAMP2 generated by the second ramp generating circuit 620 may be different. In some embodiments, a value of each of the plurality of current sources cSa1 to cSaN in the first ramp circuit 611 and a value of each of the plurality of current sources CSc1 to CScN in the second ramp circuit 621 may be different. For example, the current source cSa1 may have a smaller value than the current source CSc1. The slope of the ramp period of the first ramp signal RAMP1 may be gentler than the slope of the ramp period of the second ramp signal RAMP2.

In an embodiment, in the first ramp circuit 611 and the second ramp circuit 621, the number of the current sources controlled by one ramp activation signal RE may be different. For example, by way of one ramp activation signal RE1, one current source cSa1 may be controlled in the first ramp circuit 611 and two current sources CSc1 and CSc2 may be controlled in the second ramp circuit 621.

In some embodiments, the current value generated by each current source CSb1 to CSbM of the first emphasis circuit 613 and the current value generated by each current source CSd1 to CSdM of the second emphasis circuit 623 may be different.

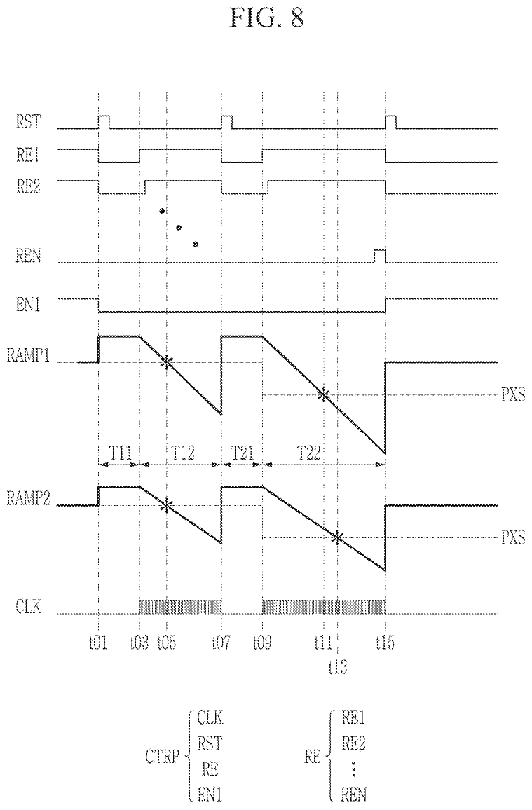

FIG. 8 is a timing diagram for explaining an operation of a ramp signal generator according to an embodiment.

The timing controller (270 of FIG. 2) may output a ramp reset signal RST, a first emphasis activation signal EN1, a ramp activation signal RE, and a clock signal CLK to a ramp signal generator 260. The ramp reset signal RST may be a signal for controlling the ramp signal generator 260 to generate the ramp signal. The ramp signal generator 260 may generate the ramp signal in response to receiving the ramp reset signal RST. In some embodiments, the ramp signal generator 600 may generate the ramp activation signal RE based on the ramp reset signal RST and the clock signal CLK.

Referring to FIGS. 6 and 7, the first ramp generating circuit 610 may generate a first ramp signal RAMP1 based on the ramp activation signal RE and the emphasis activation signal EN1, and the second ramp generating circuit 620 may generate a second ramp signal RAMP2 based on the ramp activation signal RE and the first emphasis activation signal EN1. For brevity of the drawing and for better comprehension and ease of description, constituent elements unnecessary to explain an embodiment may be omitted. The timing diagram of FIG. 8 is schematically shown, and the actual driving waveform of a general ramp signal generator may be different from the waveform shown in FIG. 8.

On the other hand, according to embodiments, before a time t01, the selection signal SEL may be activated, and the power source voltage VDD may be provided by a reset signal (RS in FIG. 3). In addition, at a time t09, the transmission signal (TS in FIG. 3) may be activated and the pixel signal PXS may be output from the plurality of pixels 211 of the pixel array 210 of 2. Accordingly, the pixel signal PXS may be a logic high from a time t01 to a time t09, and a logic low from a time t09.

If the ramp reset signal RST is the logic high, the clock signal CLK and the first to n-th ramp activation signals RE1 to REN may be the logic low. If the ramp reset signal RST is the logic low, the clock signal CLK may toggle. For example, based on the ramp reset signal RST, which is the logic high at the time t01, the clock signal CLK and first to n-th ramp activation signals RE1 to REN may become the logic low. Although the voltage level of the first emphasis activation signal EN1 is shown to be changed from the logic high to the logic low at the time t01, the range of the present disclosure is not limited thereto, and the voltage level of the first emphasis activation signal EN1 before the time t01 may be the logic low according to embodiments.

During the first reset period T11 from the time t01 to the time t03, the ramp circuit 611 may generate the first ramp signal RAMP1 having the offset voltage level based on the first to n-th ramp activation signals RE1 to REN of the logic low and the first emphasis activation signal EN1 of the logic low. The offset voltage level may be the voltage level of the first ramp signal RAMP1 generated by the activated first to n-th current sources cSa1 to cSaN and the first to M-th emphasis current sources CSb1 to CSbM.

Similarly, during the first reset period T11, the ramp circuit 621 may generate a second ramp signal RAMP2 having an offset voltage level based on the logic low first to n-th ramp activation signals RE1 to REN and the logic low first emphasis activation signal EN1. The offset voltage level may be a voltage level of the second ramp signal RAMP2 generated by the activated first to n-th current sources CSc1 to CScN and the first to m-th emphasis current sources CSd1 to CSdM.

Next, during the first sensing period T12 between time t03 and time t07, when the ramp reset signal RST is logic low, the clock signal CLK may be logic low or logic high. During the first sensing period T12, when the clock signal CLK is logic high, at least one activation signal among the first to the n-th ramp activation signals RE1 to REN may be the logic high. For example, based on the clock signal CLK, which is logic high at the time t03, the first ramp activation signal RE1 may become logic high. Then, as the clock signal CLK toggles during the first sensing period T12, the number of the logic low ramp activation signals RE1 to REN may decrease.

During the first sensing period T12, the first ramp generating circuit 610 may generate the first ramp signal RAMP1 based on the first to n-th ramp activation signals RE1 to REN and the first emphasis activation signal EN1. During the first sensing period T12, as the number of the first to n-th ramp activation signals RE1 to REN of the logic low decreases, the number of the activated current sources may decrease. That is, the ramp circuit 611 may generate the first ramp signal RAMP1 whose voltage level decreases.

Similarly, during the first sensing period T12, the second ramp generating circuit 620 may generate the second ramp signal RAMP2 based on the first to n-th ramp activation signals RE1 to REN and the first emphasis activation signal EN1. During the first sensing period T12, as the number of the first to n-th ramp activation signals RE1 to REN of the logic low decreases, the number of the activated current sources may decrease. That is, the ramp circuit 621 may generate the second ramp signal RAMP2 having a voltage level that decreases. In some embodiments, the voltage level of the first ramp signal RAMP1 may decrease more steeply than the degree to which the voltage level of the second ramp signal RAMP2 decreases.

In the first sensing period T12, the first emphasis activation signal ENI may maintain the logic low. Accordingly, the first to M-th emphasis current sources CSb1 to CSbM and the first to M-th emphasis current sources CSd1 to CSdM may be activated.

After a time t07, the operation of the ramp signal generator 600 is similar to the operation during the time t01 to the time t07. Thus, for convenience of explanation, a further detailed description thereof is omitted.

The lengths of the first sensing period T12 and the second sensing period T22 may be determined based on the ramp reset signal RST and the clock signal CLK. For example, since the ramp reset signal RST is the logic low and the number of the ramp activation signals RE1 to REN, which are logic low, decreases while the clock signal CLK is toggling, the number of the deactivated current sources may increase. That is, as the ramp reset signal RST is the logic low and the toggling period of the clock signal CLK is longer, the voltage level of the first ramp signal RAMP1 and the second ramp signal RAMP2 may be greatly reduced.

As shown in FIG. 8, the second sensing period T22 between the time t09 and the time t15 may be longer than the length of the first sensing period. Accordingly, in the second sensing period T22, the N-th activation signal REN, which did not become the logic high in the first sensing period T12, may become the logic high. That is, as the number of the current sources cSa1 to cSaN deactivated during the second sensing period T22 increases to be greater than the number of the current sources cSa1 to cSaN deactivated during the first sensing period T12, the voltage level of the first ramp signal RAMP1 during the second sensing period T22 may decrease more significantly than the voltage level of the first ramp signal RAMP1 during the first sensing period T12. In addition, as the number of the current sources CSc1 to CScN deactivated during the second sensing period T22 is greater than the number of the current sources CSc1 to CScN deactivated during the first sensing period, the voltage level of the second ramp signal RAMP2 during the second sensing period T22 may decrease more significantly than the voltage level of the second ramp signal RAMP2 during the first sensing period.

Referring to FIG. 5, the polarity of the output voltage VOUT11, which is the output of the comparator 441, may be changed at the time where the pixel signal PXS and the first ramp signal RAMP1 have the same value. The counter 451 may count the clock signal CLK from the time t03 to the time t05 when the polarity of the output voltage VOUT11 changes. The first counter 451 may determine the digital signal value of the pixel signal PXS by counting the clock signal CLK up to the time when the pixel signal PXS and the first ramp signal RAMP1 are identical.

Similarly, at a time when the pixel signal PXS and the second ramp signal RAMP2 have the same value, the polarity of the output voltage (VOUT12), which is the output of the comparator 442, may change. The counter 452 may count the clock signal CLK from the time t03 to the time t05 when the polarity of the output voltage VOUT11 changes. The second counter 452 may determine the digital signal value of the pixel signal PXS by counting the clock signal CLK up to the time when the pixel signal PXS and the second ramp signal RAMP2 are identical.

Since the ramp signal generator 600 generates the first ramp signal RAMP1 and second ramp signal RAMP2 based on the same ramp reset signal RST, the clock signal CLK, the first emphasis activation signal EN1, and the ramp activation signal RE, the first ramp signal RAMP1 and the second ramp signal RAMP2 may have the reset period and the sensing period of the same length.

Since the slopes of the first ramp signal RAMP1 and the second ramp signal RAMP2 are different, the time at which the pixel signal PXS and the first ramp signal RAMP1 become the same and the time at which the pixel signal PXS and the second ramp signal RAMP2 become the same may be different. That is, a time point at which the polarity of the output signal VOUT11 changes and a time point at which the polarity of the output signal VOUT12 changes may be different. For example, since the slope of the second ramp signal RAMP2 is gentler than the slope of the first ramp signal RAMP1, the time at which the polarity of the output signal VOUT12 changes may be later than the time at which the polarity of the output signal VOUT11 changes. For example, as shown in FIG. 8, the polarity of the output signal VOUT11 of the first comparator 441 may change at the time t11. In addition, the polarity of the output signal VOUT12 of the second comparator 442 may change at the time t13.

As shown in FIG. 5, the first comparator 441 and the second comparator 442 share the power source voltage VDD and the ground voltage. Therefore, the power source voltage VDD may supply the current to the first comparator 441 and the second comparator 442 through the same wire.

At the time when the value of the pixel signal PXS input to the first comparator 441 and the value of the first ramp signal RAMP1 are the same, or the time when the value of the pixel signal PXS input to the second comparator 442 and the value of the second ramp signal RAMP2 are the same, a current fluctuation may occur. The current fluctuation phenomenon may be a phenomenon in which a fine change occurs in the current flowing in the first comparator 441 and the second comparator 442 due to a coupling phenomenon between the current flowing in the first comparator 441 and the current flowing in the second comparator 442. That is, the current flowing through the first comparator 441 may affect the current flowing through the second comparator 442, and the current flowing through the second comparator 442 may affect the current flowing through the first comparator 441.

At the time t11 when the first ramp signal RAMP1 input to the first comparator 441 and the pixel signal PXS have the same value, the current fluctuation of the current flowing through the first comparator 441 may affect the second comparator 442. As the current flowing through the second comparator 442 changes, a change may occur at the time when the second ramp signal RAMP2 has the same value as the pixel signal PXS. Accordingly, the counter 452 may not accurately count the pixel signal PXS. Therefore, if the interval between the time t11 when the first ramp signal RAMP1 and the pixel signal PXS have the same value and the time t13 when the second ramp signal RAMP2 has the same value as the pixel signal PXS is short, there is a possibility that an accurate pixel signal cannot be read out.

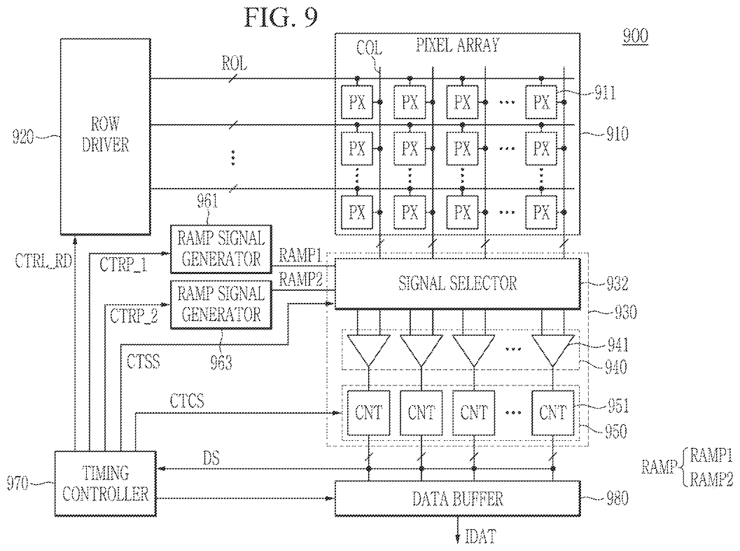

FIG. 9 is an example block diagram of an image sensor according to an embodiment.

Referring to FIG. 9, an image sensor 900 may include a pixel array 910, a row driver 920, an ADC 930, a first ramp signal generator 961, a second ramp signal generator 963, a timing controller 970, and a data buffer 980. For convenience of explanation, a further description of the constituent elements of FIG. 9, which are identical to or similar to the constituent elements of the image sensor 200 of FIG. 2, is omitted.

The timing controller 970 may control the operation or the timing of the row driver 920, ADC 930, the first ramp signal generator 961, and the second ramp signal generator 963 by outputting the control signal or the clock signal to each of the row driver 920, the ADC 930, the first ramp signal generator 961, and the second ramp signal generator 963.

The first ramp signal generator 961 may generate a first ramp signal RAMP1. For example, the first ramp signal generator 961 may generate the first ramp signal RAMP1 that linearly increases or decreases during a specific period. For example, the first ramp signal generator 961 may operate based on the first ramp control signal CTRP1 provided from the timing controller 970. The first ramp control signal CTRP1 may include a first reset signal, a first ramp activation signal, and a first activation signal for generating the first ramp signal RAMP1.

When the first reset signal is activated, the first ramp signal generator 961 may generate the first ramp activation signal and the ramp signal RAMP1 based on the first activation signal. For example, the first ramp signal generator 961 may start with an offset voltage level corresponding to the first activation signal and the first ramp activation signal when the first reset signal is activated, and may generate the first ramp signal RAMP1 that decreases with a constant slope when the first ramp activation signal is activated.

The second ramp signal generator 963 may generate a second ramp signal RAMP2. For example, the second ramp signal generator 963 may generate the second ramp signal RAMP2 that increases or decreases linearly during a specific period. For example, the second ramp signal generator 963 may operate based on the second ramp control signal CTRP2 provided from the timing controller 970. The second ramp control signal CTRP2 may include a second reset signal, a second ramp activation signal, and a second activation signal for generating the second ramp signal RAMP2.

When the second reset signal is activated, the second ramp signal generator 963 may generate a second ramp signal RAMP2 based on the second ramp activation signal and the second activation signal. For example, the second ramp signal generator 963 starts with an offset voltage level corresponding to the second activation signal and the second ramp activation signal when the second reset signal is activated, and may generate the second ramp signal RAMP2 that decreases with a constant slope when the second ramp activation signal is activated.

Although it is shown in FIG. 9 that the image sensor 900 includes two ramp signal generators, the present disclosure is not limited thereto. For example, according to embodiments, one ramp signal generator may generate two ramp signals based on two ramp control signals.

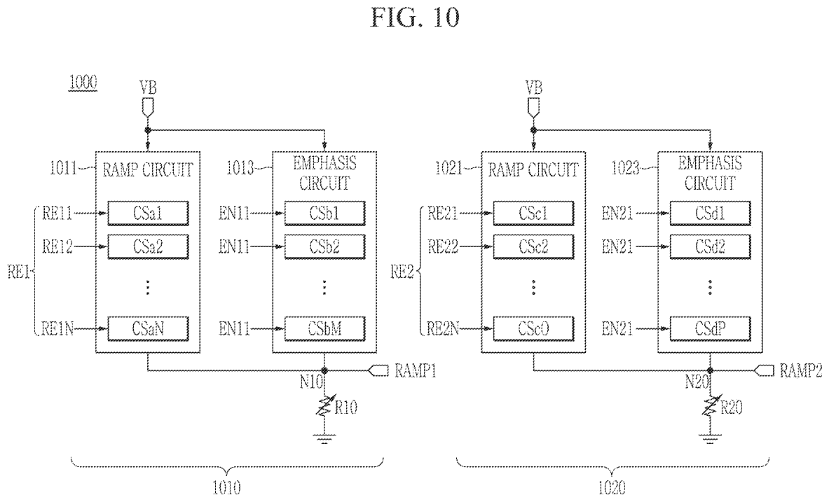

FIG. 10 is a block diagram of a ramp signal generator according to an embodiment.

Referring to FIG. 10, a ramp signal generator 1000 may include a first ramp generating circuit 1010 and a second ramp generating circuit 1020. The first ramp generating circuit 1010 may generate a first ramp signal RAMP1, and the second ramp generating circuit 1020 may generate a second ramp signal RAMP2. For convenience of explanation, a further description of the constituent elements of FIG. 10 identical to or similar to those of the ramp signal generator 600 of FIG. 6 are omitted.

In some embodiments, a first ramp generating circuit 1010 may include a first ramp circuit 1011, a first emphasis circuit 1013, and an output resistor R10.

The first ramp generating circuit 1010 may generate a first ramp signal RAMP1 based on the bias signal VB and the first ramp activation signal RE during the ramp period.

The first ramp circuit 1011 may receive the bias signal VB from a power supply circuit. The first ramp circuit 1011 may receive the first ramp activation signal RE1 as a ramp control signal CTRP from the timing controller (270 in FIG. 2). The first ramp activation signal RE1 may include a plurality of ramp activation signals RE11 to RE1N.

The first ramp circuit 1011 may include a plurality of current sources cSa1 to cSaN. Each of the plurality of current sources cSa1 to cSaN may operate in response to each of the bias signal VB and the plurality of ramp activation signals RE11 to RE1N.

The first emphasis circuit 1013 may be connected to the first ramp circuit 1011 through the output node N10. The output node N10 may be a node that outputs the first ramp signal RAMP1. The first emphasis circuit 1013 may receive the bias signal VB from the power supply circuit. The first emphasis circuit 1013 may receive a first emphasis activation signal EN11 from the timing controller 270.

The first emphasis circuit 1013 may include a plurality of emphasis current sources CSb1 to CSbM. Each of the plurality of emphasis current sources CSb1 to CSbM may operate in response to the first emphasis activation signal EN11. Each of the plurality of first emphasis current sources CSb1 to CSbM may receive the first emphasis activation signal EN11 from the timing controller 270. Each of the plurality of first emphasis current sources CSb1 to CSbM may control the voltage level of the first ramp signal RAMP1 based on the first emphasis activation signal EN11. The voltage level of the first ramp signal RAMP1 may correspond to the number of the plurality of emphasis current sources CSb1 to CSbM.

The output resistor R10 may be connected to the first ramp circuit 1011 and the first emphasis circuit 1013 through the output node N10. In an embodiment, the voltage level of the first ramp signal RAMP1 during the reset period and the sensing period may be proportional to the size of the output resistor R10.

In some embodiments, the second ramp generating circuit 1020 may include a second ramp circuit 1021, a second emphasis circuit 1023, and an output resistor R20.

The second ramp generating circuit 1020 may generate a second ramp signal RAMP2 based on the bias signal VB and the second ramp activation signal RE2 during the ramp period.

The second ramp circuit 1021 may receive the bias signal VB from a power supply circuit. The second ramp circuit 1021 may receive the second ramp activation signal RE2 as a ramp control signal CTRP from the timing controller (270 in FIG. 2). The second ramp activation signal RE2 may include a plurality of second ramp activation signals RE21 to RE2N.

The second ramp circuit 1021 may include a plurality of current sources CSc1-cScO. Each of the plurality of current sources CSc1-cScO may operate in response to the bias signal VB. For example, each of the plurality of current sources CSc1-cScO may be activated in response to the bias signal VB. Each of the plurality of current sources CSc1-cScO may operate in response to each of the plurality of second ramp activation signals RE21 to RE2N.

For example, the first current source CSc1 may generate the second ramp signal RAMP2 in response to the second ramp activation signal RE21, the second current source CSc2 may generate the second ramp signal RAMP2 in response to the second ramp activation signal RE22, and the O-th current source cScO may generate the second ramp signal RAMP2 in response to the N-th ramp activation signal RE2N.

The second emphasis circuit 1023 may be connected to the ramp circuit 1021 through the output node N20. The output node N20 may be a node that outputs the second ramp signal RAMP2. The second emphasis circuit 1023 may receive the bias signal VB from the power supply circuit. The second emphasis circuit 1023 may receive the second emphasis activation signal EN21 from the timing controller 270.

The second emphasis circuit 1023 may control the voltage level of the second ramp signal RAMP2 during the reset period and the sensing period based on the bias signal VB and the second emphasis activation signal EN21.

The second emphasis circuit 1023 may include a plurality of second emphasis current sources CSd1 to CSdP. Each of the plurality of second emphasis current sources CSd1 to CSdP may operate in response to the second emphasis activation signal EN21. Each of the plurality of second emphasis current sources CSd1 to CSdP may receive the second emphasis activation signal EN21 from the timing controller 270. Each of the plurality of second emphasis current sources CSd1 to CSdP may control the voltage level of the second ramp signal RAMP2 based on the second emphasis activation signal EN21. The voltage level of the second ramp signal RAMP2 may correspond to the number of the plurality of second emphasis current sources CSd1 to CSdP. For example, as the number of the plurality of current sources CSd1 to CSdP included in the second emphasis circuit 1023 increases, the voltage level of the second ramp signal RAMP2 may increase.

The output resistor R20 may be connected to the ramp circuit 1021 and the second emphasis circuit 1023 through the output node N20. The output resistor R20 may be connected between the output node N20 and the ground node that receives the ground power. The output resistor R20 may be a variable resistor. In an embodiment, the voltage level of the second ramp signal RAMP2 may be proportional to the size of the output resistor R20.

In some embodiments, the first emphasis circuit 1013 and the second emphasis circuit 1023 may include PMOS transistors. In this case, the first emphasis circuit 1013 may increase the voltage level of the first ramp signal RAMP1 based on the first emphasis activation signal EN11 of the enable level, and the second emphasis circuit 1023 may increase the voltage level of the second ramp signal RAMP2 based on the second emphasis activation signal EN21 of the enable level. In some embodiments, the enable level may be logic low. However, the present disclosure is not limited thereto, and the emphasis circuit 1013 and the emphasis circuit 1023 may include NMOS transistors according to some embodiments.

The first ramp generating circuit 610 and the second ramp generating circuit 620 of the ramp signal generator 600 shown in FIG. 6 can generate the first ramp signal RAMP1 and the second ramp signal RAMP2 based on the same ramp activation signal RE and emphasis activation signal EN. On the other hand, the first ramp generating circuit 1010 of the ramp signal generator 1000 may generate the first ramp signal RAMP1 based on the first ramp activation signal RE1 and the first emphasis activation signal EN11, and the second ramp generating circuit 1020 may generate the second ramp signal RAMP2 based on the second ramp activation signal RE2 and the second emphasis activation signal EN21. Accordingly, the first ramp generating circuit 1010 and the second ramp generating circuit 1020 may generate the first ramp signal RAMP1 and the second ramp signal RAMP2 having different lengths or having the reset period and the sensing period starting at different timings. The first ramp generating circuit 1010 and the second ramp generating circuit 1020 may generate the first ramp signal RAMP1 and the second ramp signal RAMP2 having the different offset voltage levels.

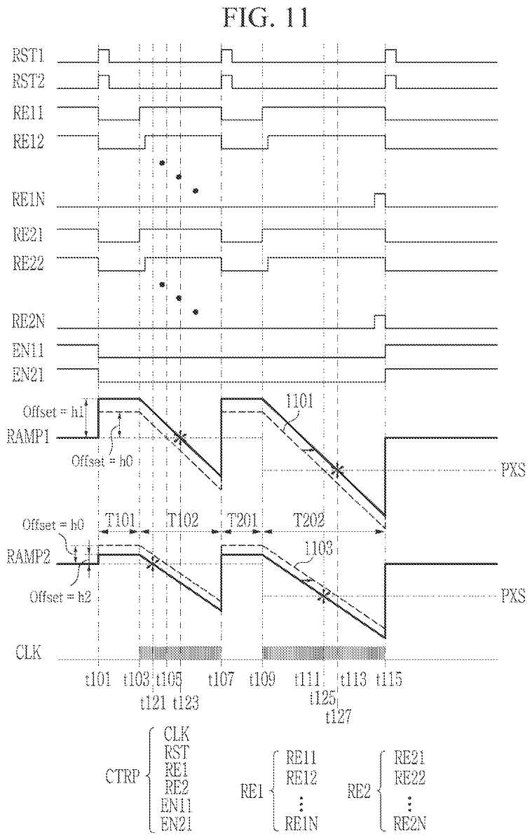

FIG. 11 is a timing diagram for explaining an operation of a ramp signal generator according to an embodiment.

Referring to FIGS. 9 and 10, a first ramp generating circuit 1010 may generate a first ramp signal RAMP1 based on a first ramp activation signal RE1 and a first emphasis activation signal EN11, and a second ramp generating circuit 1020 may generate a second ramp signal RAMP2 based on a second ramp activation signal RE2 and a second emphasis activation signal EN21. The timing diagram of FIG. 11 is schematically shown, and an actual driving waveform of the ramp signal generator may be different from the waveform shown in FIG. 11.

The ramp signal generator 1000 may receive a first reset signal RST1, a first clock signal CLK1, and a first ramp activation signal RE1. The first ramp activation signal RE1 may include first to N-th ramp activation signals RE11 to RE1N. In some embodiments, the ramp signal generator 1000 may generate the first ramp activation signal RE1 based on the first reset signal RST1 and the first clock signal CLK1.

In addition, the ramp signal generator 1000 may receive a second reset signal RST2, a second clock signal CLK2, and a second ramp activation signal RE2. The second ramp activation signal RE2 may include first to n-th ramp activation signals RE21 to RE2N. In some embodiments, the ramp signal generator 1000 may generate the second ramp activation signal RE2 based on the second reset signal RST2 and the second clock signal CLK2.

On the other hand, in some embodiments, before a time t101, the selection signal SEL may be activated, and the power source voltage VDD may be provided by the reset signal (RS in FIG. 3). In addition, at the time t109, the transmission signal (TS in FIG. 3) is activated and a pixel signal PXS may be output from a plurality of pixels 211 of the pixel array 210 of FIG. 2. Accordingly, the pixel signal PXS may be the logic high from the time t101 to the time t109 and the logic low after the time t109.

During the first reset period T101 between the time t101 and the time t103, the ramp circuit 1011 may generate a first ramp signal RAMP1 having an offset level voltage based on the first to n-th ramp activation signals RE11 to RE1N which are the logic low and the first emphasis activation signal EN11 which is the logic low. The offset voltage level may be the voltage level of the first ramp signal RAMP1 generated by the activated first to N-th current sources (cSa1 to cSaN of FIG. 10) and first to M-th emphasis current sources (CSb1 to CSbM of FIG. 10).

Likewise, during the first reset period T101, the ramp circuit 1021 may generate the second ramp signal RAMP2 having the offset voltage level based on the first to N-th ramp activation signals RE21 to RE2N of the logic low and the second emphasis activation signal EN21 of the logic low. The offset voltage level may be the voltage level of the second ramp signal RAMP2 generated by the activated first to N-th current sources (CSc1 to CScN of FIG.

10) and first to M-th emphasis current sources (CSd1 to CSdM of FIG. 10). The offset voltage level may be the voltage level of the second ramp signal RAMP2 generated by the activated first to O-th current sources CSc1-cScO and the first to P-th emphasis current sources CSd1 to CSdP.

Next, during the first sensing period T102 from the time t103 to the time t107, the first reset signal RST1 may be the logic low. When the first clock signal CLK1 is the logic high in the first sensing period T102, at least one activation signal among the first to N-th ramp activation signals RE11 to RE1N may be the logic high. For example, based on the first clock signal CLK1, which is the logic high at time t103, the first ramp activation signal RE11 may become the logic high. Then, as the first clock signal CLK1 toggles during the first sensing period T102, the number of the ramp activation signals RE11 to RE1N of the logic low may decrease.

During the first sensing period T102, the second reset signal RST2 may be the logic low. If the second clock signal CLK2 is the logic high during the first sensing period T102, at least one activation signal among the first to N-th ramp activation signals RE21 to RE2N may be the logic high. For example, based on the second clock signal CLK2, which is the logic high at the time t103, the second ramp activation signal RE21 may become the logic high. Then, as the second clock signal CLK2 toggles during the first sensing period T102, the number of logic low ramp activation signals RE21 to RE2N may decrease.

In some embodiments, the voltage level of the first ramp signal RAMP1 may decrease more steeply than the voltage level of the second ramp signal RAMP2. For example, the voltage level of the first ramp signal RAMP1 may decrease with the first slope due to the ramp activation signals RE11 to RE1N decreasing according to the toggling of the first clock signal CLK1 during the first sensing period T102. During the first sensing period T102, the voltage level of the second ramp signal RAMP2 may decrease with the second slope by the ramp activation signals RE21 to RE2N, which decrease according to the toggling of the second clock signal CLK2. The first slope may be greater than the second slope.

The operation of the ramp signal generator 1000 from the time t107 to the time t115 may be the same as or similar to the operation of the ramp signal generator 1000 from the time t101 to the time t107.

The lengths of the first sensing period T102 and the second sensing period T202 in which the voltage level of the first ramp signal RAMP1 decreases may be determined based on the first reset signal RST1 and the first clock signal CLK1. The lengths of the first sensing period T102 and the second sensing period T202 in which the voltage level of the second ramp signal RAMP2 decreases may be determined based on the second reset signal RST2 and the second clock signal CLK2.

Since the ramp signal generator 1000 generates the first ramp signal RAMP1 based on the first reset signal RST1 and the first clock signal CLK1, and the second ramp signal RAMP2 based on the second reset signal RST2 and the second clock signal CLK2, the reset period and the sensing period of the first ramp signal RAMP1 and the second ramp signal

RAMP2 may start at different times and have different lengths. Furthermore, the ramp signal generator 1000 may control the offset voltage level of the first ramp signal RAMP1 based on the first emphasis activation signal EN11 and control the offset voltage level of the second ramp signal RAMP2 based on the second emphasis activation signal EN21. Accordingly, the ramp signal generator 1000 may generate the first ramp signal RAMP1 and the second ramp signal RAMP2 having the different offset voltage levels. For example, the first ramp generating circuit 1010 and the second ramp generating circuit 1020 may generate the first ramp signal RAMP1 and the second ramp signal RAMP2 having the different offsets based on the first emphasis activation signal EN11 and the second emphasis activation signal EN21, respectively.

Referring to FIG. 11, the first ramp signal in the case of having the offset h0 is shown as a first graph 1101, and the second ramp signal in the case of having an offset h0 is shown as a second graph 1103. The first graph 1101 may have the same value as the pixel signal PXS at the time point t105 in the first sensing period T102 and the time point t111 in the second sensing period T202. The second graph 1103 may have the same value as the pixel signal PXS at the time point t105 in the first sensing period T102 and the time point t113 in the second sensing period T202. That is, in the sensing period, an interval between the time point at which the digital signal value of the pixel signal PXS is determined using the first ramp signal and the time point at which the digital signal value of the pixel signal PXS is determined using the second ramp signal may be t113-t111.

On the other hand, the first ramp generating circuit 1010 may generate the first ramp signal RAMP1 having the offset h1 larger than the offset h0. In this case, the first ramp signal RAMP1 may have the same value as the pixel signal PXS in the first sensing period T102 at the time t123 and in the second sensing period T202 at the time t127. In addition, the second ramp generating circuit 1020 may generate the second ramp signal RAMP2 having the offset h2 smaller than the offset h0. In this case, the second ramp signal RAMP2 may have the same value as the pixel signal PXS in the first sensing period T102 at the time t121 and in the second sensing period T202 at the time t125. That is, in the sensing period, the interval between the time when the digital signal value of the pixel signal PXS is determined using the first ramp signal RAMP1 and the time when the digital signal value of the pixel signal PXS is determined using the second ramp signal RAMP2 may be t127-t125.

The interval between the time at which the comparator (940 in FIG. 9) determines the value of the pixel signal PXS by using the first ramp signal RAMP1 and the time at which the comparator 940 determines the value of the pixel signal PXS by using the second ramp signal RAMP2 may further increase. Therefore, the influence of the current fluctuation that occurs when the comparator 940 determines the digital signal value of the pixel signal PXS by using the second ramp signal RAMP2 on the time at which the digital signal value of the pixel signal PXS is determined using the first ramp signal RAMP1 may be reduced.

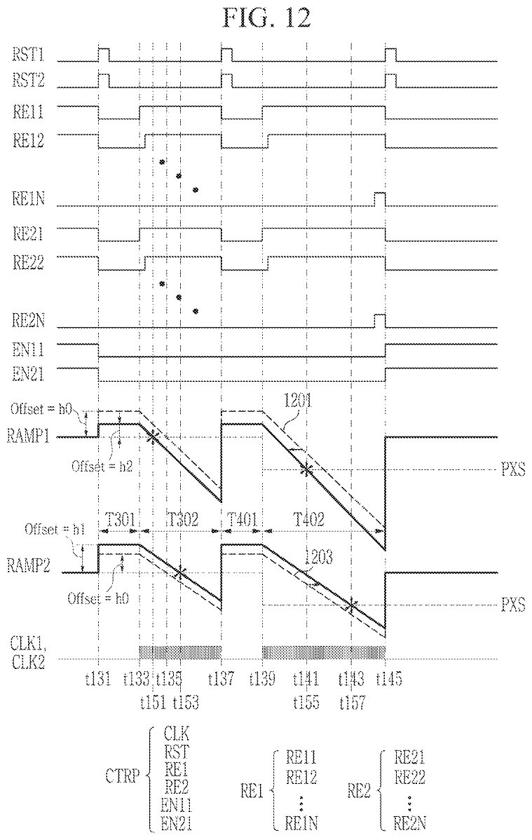

FIG. 12 is a timing diagram for explaining an operation of a ramp signal generator according to an embodiment. For convenience of explanation, a further description of the same or similar aspects as the timing diagram of the ramp signal generator in FIG. 11 is omitted.

In some embodiments, the selection signal SEL may be activated before the time t131, and the power source voltage VDD may be provided by a reset signal (RS in FIG. 3). In addition, at the time t139, the transmission signal (TS in FIG. 3) is activated and the pixel signal PXS may be output from the plurality of pixels 211 of the pixel array 210 of FIG. 2. Accordingly, the pixel signal PXS may be the logic high from the time t131 to the time t139 and the logic low after the time t139.

During the first reset period T301 between the time t131 and the time t133, the ramp circuit 1011 may generate the first ramp signal RAMP1 having an offset level voltage based on first to n-th ramp activation signals RE11 to RE1N, which is the logic low, and the first emphasis activation signal EN11, which is the logic low.

Similarly, during the first reset period T301, the ramp circuit 1021 may generate the second ramp signal RAMP2 having the offset voltage level based on the first to n-th ramp activation signals RE21 to RE2N which is the logic low and the second emphasis activation signal EN21 which is the logic low.

Thereafter, during the first sensing period T302 between the time t133 and the time t137, the first reset signal RST1 may be the logic low. If the first clock signal CLK1 is the logic high in first sensing period T302, at least one activation signal among the first to n-th ramp activation signals RE11 to RE1N may be the logic high. Then, as the first clock signal CLK1 toggles during the first sensing period T302, the number of the ramp activation signals RE11 to RE1N of the logic low may decrease.

Also, during the first sensing period T302, the second reset signal RST2 may be the logic low. If the second clock signal CLK2 is the logic high during the first sensing period T302, at least one activation signal among the first to n-th ramp activation signals RE21 to RE2N may be the logic high. Then, as the second clock signal CLK2 toggles during the first sensing period T302, the number of the ramp activation signals RE21 to RE2N of the logic low may decrease.

Since the operation of the ramp signal generator 1000 after the time t137 is similar to the operation from the time t131 to the time t137, a further detailed description thereof is omitted.

As described above, the ramp signal generator 1000 may control the offset voltage level of the first ramp signal RAMP1 based on the first emphasis activation signal EN11 and control the offset voltage level of the second ramp signal RAMP2 based on the second emphasis activation signal EN21. Accordingly, the ramp signal generator 1000 may generate the first ramp signal RAMP1 and the second ramp signal RAMP2 having the different offset voltage levels. For example, the first ramp generating circuit 1010 and the second ramp generating circuit 1020 may generate the first ramp signal RAMP1 and the second ramp signal RAMP2 having the different offsets based on the first emphasis activation signal EN11 and the second emphasis activation signal EN21, respectively.

Referring to FIG. 12, the first ramp signal in the case of having the offset h0 is shown as a first graph 1201, and the second ramp signal in the case of having the offset h0 is shown as a second graph 1203. The first graph 1201 may have the same value as the pixel signal PXS at the time point t135 in the first sensing period T302 and the time point t141 in the second sensing period T402. The second graph 1203 may have the same value as the pixel signal PXS at the time point t135 in the first sensing period T302 and the time point t143 in the second sensing period T402. That is, in the sensing period, the interval between the time at which the digital signal value of the pixel signal PXS is determined using the first ramp signal and the time point at which the digital signal value of the pixel signal PXS is determined using the second ramp signal may be t143-t141.

The first ramp generating circuit 1010 may generate the first ramp signal RAMP1 having the offset h2 smaller than the offset h0. In this case, the first ramp signal RAMP1 may have the same value as the pixel signal PXS at the time t151 in the first sensing period T302 and at the time t155 in the second sensing period T402. The second ramp generating circuit 1020 may generate the second ramp signal RAMP2 having an offset h1 greater than the offset h0. In this case, the second ramp signal RAMP2 may have the same value as the pixel signal PXS at the time point t153 in the first sensing period T302 and at the time point t157 in the second sensing period T402. That is, in the sensing period, the interval between the time at which the digital signal value of the pixel signal PXS is determined using the first ramp signal RAMP1 and the time at which the digital signal value of the pixel signal PXS is determined using the second ramp signal RAMP2 may be t157-t155.

Thus, according to embodiments, by setting the offsets of the first ramp signal RAMP1 and the second ramp signal RAMP2 differently, the interval between the time at which the comparator (940 in FIG. 9) determines the value of the pixel signal PXS by using the first ramp signal RAMP1 and the time at which the comparator 940 determines the value of the pixel signal PXS by using the second ramp signal RMAP2 may increase further. Therefore, the influence of the current fluctuation that occurs when the comparator 940 determines the digital signal value of the pixel signal PXS by using the second ramp signal RAMP2 on the time at which the digital signal value of the pixel signal PXS is determined using the first ramp signal RAMP1 may be reduced.

In FIG. 11, the time at which the digital signal value of the pixel signal PXS is determined using the first ramp signal RAMP1 having the large slope may be after the time at which the digital signal value of the pixel signal PXS is determined using the second ramp signal RAMP2 having the small slope. However, it may be difficult to significantly increase the interval between the time at which the first ramp signal RAMP1 determines the digital signal value and the time at which the second ramp signal RAMP2 determines the digital signal value depending on the slope values of the first ramp signal RAMP1 and the second ramp signal RAMP2.

On the other hand, in FIG. 12, the time at which the digital signal value of the pixel signal PXS is determined using the first ramp signal RAMP1 having the large slope may be before the time at which the digital signal value of the pixel signal PXS is determined using the second ramp signal RAMP2 having the small slope. Accordingly, regardless of the slope values of the first ramp signal RAMP1 and the second ramp signal RAMP2, the interval between the time when the first ramp signal RAMP1 determines the digital signal value and the time when the second ramp signal RAMP2 determines the digital signal value may be increased.

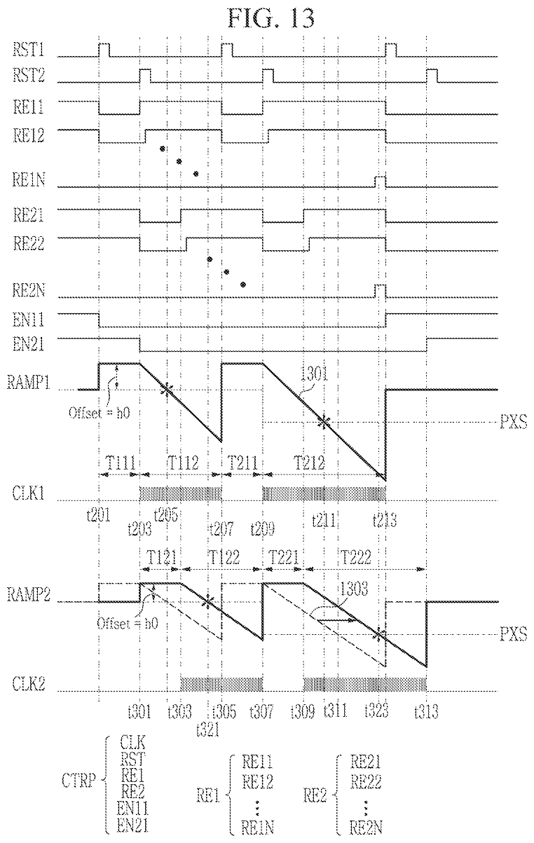

FIG. 13 is a timing diagram for explaining an operation of a ramp signal generator according to an embodiment.

Referring to FIG. 13, the ramp signal generator 1000 may generate a first ramp signal RAMP1 based on the first reset signal RST1 and the first clock signal CLK1. The ramp signal generator 1000 may generate the second ramp signal RAMP2 based on the second reset signal RST2 having the different timing from the first reset signal RST1 and the second clock signal CLK2 having the different timing from the first clock signal CLK1. For convenience of explanation, a further description of the same or similar aspects as the timing diagram of the ramp signal generator in FIG. 11 is omitted.

During the first reset period T111 between the time t201 and the time t203, the ramp circuit 1011 may generate the first ramp signal RAMP1 having a reset level voltage based on the first to n-th ramp activation signals RE11 to RE1N, which is the logic low and the first emphasis activation signal EN11, which is the logic low.

During the first reset period T121 between the time t301 and the time t303, the ramp circuit 1021 may generate a second ramp signal RAMP2 having a reset level voltage based on the first to N-th ramp activation signals RE11 to RE1N of the logic low and the second emphasis activation signal EN21 of the logic low.

In the first sensing period T112, the first to M-th emphasis current sources CSb1 to CSbM may be activated in response to the first emphasis activation signal EN11 of the logic low. In addition, the first to P-th emphasis current sources CSd1 to CSdP may be activated in response to the second emphasis activation signal EN21 of the logic low. Accordingly, during the first sensing period T112, the first to M-th emphasis current sources CSb1 to CSbM may increase the voltage level of the first ramp signal RAMP1. During the first sensing period T112, the first ramp generating circuit 1010 may generate the first ramp signal RAMP1 based on the first to n-th ramp activation signals RE11 to RE1N and the first emphasis activation signal EN11.

In addition, the first to P-th emphasis current sources CSd1 to CSdP may increase the voltage level of the second ramp signal RAMP2 during the first sensing period T122. The second ramp generating circuit 1020 may generate a second ramp signal RAMP2 based on the first to n-th ramp activation signals RE21 to RE2N and the second emphasis activation signal EN21 during the first sensing period T122.

In the first reset period T111, the second reset signal RST2 may maintain the logic low. Thereafter, in the first reset period T121, the second reset signal RST2 may be the logic high.

Then, in the first sensing period T112 between the time t203 and the time t207, when the first reset signal RST1 is the logic low, the first clock signal CLK1 may be the logic low or logic high. If the first clock signal CLK1 is the logic high in the first sensing period T112, at least one activation signal among the first to N-th ramp activation signals RE11 to RE1N may be the logic high. Then, as the first clock signal CLK1 toggles in the first sensing period T112, the number of the ramp activation signals RE11 to RE1N of the logic low may decrease.

Also, in the first sensing period T122 between the time t303 and the time t307, when the second reset signal RST2 is the logic low, the second clock signal CLK2 may be the logic low or logic high. If the second clock signal CLK2 is the logic high in the first sensing period T122, at least one activation signal among the first to n-th ramp activation signals RE21 to RE2N may be the logic high. Then, as the second clock signal CLK2 toggles in the first sensing period T122, the number of logic low ramp activation signals RE21 to RE2N may decrease.

Since the operation of the first ramp generating circuit 1010 after at the time t207 is similar to the operation from the time t201 to the time t207, and the operation of the second ramp generating circuit 1020 after the time t307 is similar to the operation from the time t301 to the time t307, a detailed description thereof is omitted.

As shown in FIG. 13, the first ramp generating circuit 1010 may generate the first ramp signal RAMP1 starting at the time t201 based on the first reset signal RST1 and the first clock signal CLK1, and the second ramp generating circuit 1020 may generate the second ramp signal RAMP2 starting at the time t301 based on the second reset signal RST2 and the second clock signal CLK2.

When the reset signal starts at the time t201 with the offset h0, the first ramp signal is shown as a first graph 1301, and when the reset signal starts at the time t201 with the offset h0, the second ramp signal is shown as a second graph 1303. Each of the first ramp generating circuit and the second ramp generating circuit may generate the first ramp signal RAMP1 and the second ramp signal RAMP2 based on one same reset signal. The first graph 1301 may have the same value as the pixel signal PXS at the times t205 and t211. The second graph 1303 may have the same value as the pixel signal PXS at the times t205 and t311. That is, in the sensing period, the interval between the time at which the digital signal value of the pixel signal PXS is determined using the first ramp signal and the time at which the digital signal value of the pixel signal PXS is determined using the second ramp signal may be t311-t211.

In the case of the second ramp signal RAMP2 being generated based on the second reset signal RST2 with the offset h0, the second ramp signal RAMP2 may have the same value as the pixel signal PXS at the times t321 and t323. That is, the interval between the time at which the digital signal value of the pixel signal PXS is determined using the first ramp signal RAMP1 in the first sensing period T112 and the time at which the digital signal value of the pixel signal PXS is determined using the second ramp signal RAMP2 in the first sensing period T122 may be t321-t205. In addition, the interval between the time of determining the digital signal value of the pixel signal PXS by using the first ramp signal RAMP1 in the second sensing period T212 and the time of determining the digital signal value of the pixel signal PXS by using the second ramp signal RAMP2 in the second sensing period T222 may be t323-t211. Therefore, the interval between the times determining the digital signal values of the pixel signals PXS for the first ramp signal RAMP1 and the second ramp signal RAMP2 starting at the different times may be greater than t311-t211, which is the interval between the times for determining the digital signal values of the pixel signals PXS for the first ramp signal and the second ramp signal starting at the same time.

Thus, according to embodiments, by setting the first ramp signal RAMP1 and the second ramp signal RAMP2 to be started at the different times through the timing controller (970 in FIG. 9) by separately setting the reset signal, the interval between the time at which the comparator (940 in FIG. 9) determines the value of the pixel signal PXS by using the first ramp signal RAMP1 and the time at which the comparator 940 determines the value of the pixel signal PXS by using the second ramp signal RMAP2 may be further increased. Therefore, the influence of the current fluctuation that occurs when the comparator 940 determines the digital signal value of the pixel signal PXS by using the first ramp signal RAMP1 on the time of determining the digital signal value of the pixel signal PXS by using the second ramp signal RAMP2 may be reduced.

On the other hand, in FIG. 13, the second ramp signal RAMP2 is shown to start later than the first ramp signal RAMP1. However, the present invention is not limited thereto. For example, in some embodiments, the first ramp generating circuit 1010 may generate the first ramp signal RAMP1 that starts later than the second ramp signal RAMP2.

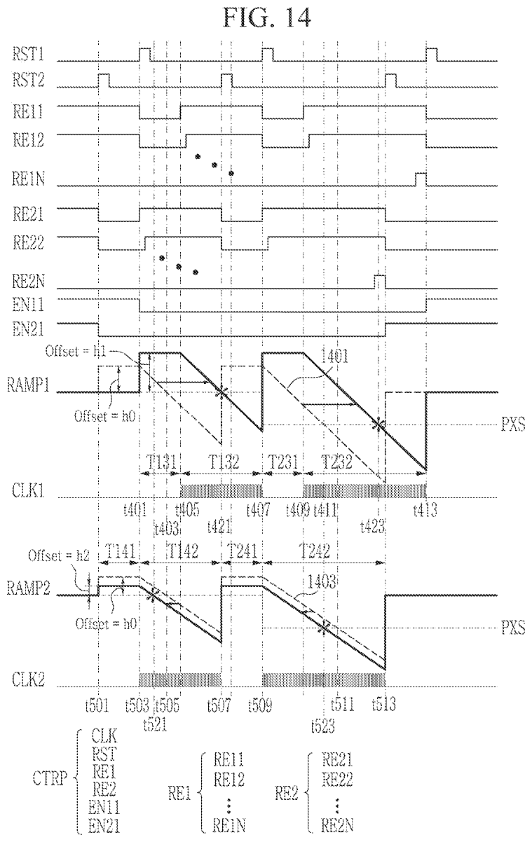

FIG. 14 is a timing diagram for explaining an operation of a ramp signal generator according to an embodiment.

FIG. 14 is a view showing a case in which a ramp signal generator 1000 generates a first ramp signal RAMP1 based on a first reset signal RST1 and a first clock signal CLK1, and generates a second ramp signal RAMP2 based on a second reset signal RST2 having a timing different from the first reset signal RST1 and a second clock signal CLK2 having a timing different from the first clock signal CLK1. For convenience of explanation, a further description of the same or similar aspects as the timing diagram of the ramp signal generator in FIG. 11 are omitted.

During a first reset period T131 from a time t401 to a time t405, a ramp circuit 1011 may generate a first ramp signal RAMP1 having a reset level voltage based on first to n-th ramp activation signals RE11 to RE1N of a logic low and a first emphasis activation signal EN11 of a logic low.

During a first reset period T141 between a time t501 and a time t503 prior to the time t401, the ramp circuit 1021 may generate a second ramp signal RAMP2 having the reset level voltage based on the first to N-th ramp activation signals RE11 to RE1N of the logic low and the second emphasis activation signal EN21 of the logic low.

During the first reset period T131, the first ramp circuit 1011 may generate the first ramp signal RAMP1 having the offset voltage level based on the first to N-th ramp activation signals RE11 to RE1N of the logic low and the first emphasis activation signal EN11 of the logic low. The offset voltage level may be the voltage level of the first ramp signal RAMP1 generated by the activated first to N-th current sources cSa1 to cSaN and first to M-th emphasis current sources CSb1 to CSbM.

During the first reset period T141, the first ramp circuit 1021 may generate a second ramp signal RAMP2 having the offset voltage level based on the first to N-th ramp activation signals RE21 to RE2N of the logic low and the first emphasis activation signal EN21 of the logic low. The offset voltage level may be a voltage level of the second ramp signal RAMP2 generated by the activated first to O-th current sources CSc1 to cScO and first to P-th emphasis current sources CSd1 to CSdP.

Then, during the first sensing period T132 between the time t405 and the time t407, if the first reset signal RST1 is the logic low, the first clock signal CLK1 may be the logic low or logic high. In the first sensing period T132, if first clock signal CLK1 is the logic high, at least one activation signal among the first to n-th ramp activation signals RE11 to RE1N may become the logic high. Then, as the first clock signal CLK1 toggles in the first sensing period T132, the number of the ramp activation signals RE11 to RE1N of the logic low may decrease.

Also, in the first sensing period T142 between the time t503 and the time t507, when the second reset signal RST2 is the logic low, the second clock signal CLK2 may be the logic low or logic high. If the second clock signal CLK2 is the logic high from the time t503 to the time t507, at least one activation signal among the first to n-th ramp activation signals RE21 to RE2N may become the logic high. Then, in the first sensing period T142, as the second clock signal CLK2 toggles, the number of the ramp activation signals RE21 to RE2N of the logic low may decrease.

During the first sensing period T132, the first ramp generating circuit 1010 may generate the first ramp signal RAMP1 based on the first to n-th ramp activation signals RE11 to RE1N and the first emphasis activation signal EN11.

The second ramp generating circuit 1020 may generate the second ramp signal RAMP2 based on the first to n-th ramp activation signals RE21 to RE2N and the second emphasis activation signal EN21 during the first sensing period T142.

Since the operation of the first ramp generating circuit 1010 after the time t407 is similar to the operation from the time t401 to the time t407, and the operation of the second ramp generating circuit 1020 after the time t507 is similar to the operation from the time t501 to the time t507, a detailed description thereof is omitted.

As shown in FIG. 14, the first ramp generating circuit 1010 may generate the first ramp signal RAMP1 starting at the time t401 based on the first reset signal RST1 and the first clock signal CLK1, and the second ramp generating circuit 1020 may generate the second ramp signal RAMP2 starting at the time t501 based on the second reset signal RST2 and the second clock signal CLK2.

Referring to FIG. 14, in a case in which the reset signal starts at the time t501 with the offset h0, the first ramp signal is shown as a first graph 1301, and in a case in which the reset signal starts at the time 501 with the offset h0, the second ramp signal is shown as a second graph 1303. In this case, each of the first ramp generating circuit and the second ramp generating circuit may generate the first ramp signal RAMP1 and the second ramp signal RAMP2 based on the same reset signal. The first graph 1301 may have the same value as the pixel signal PXS at the times t403 and t411. The second graph 1303 may have the same value as the pixel signal PXS at the times t505 and t511. As shown in FIG. 14, the time point t403 and the time point t505 may be the same. In the second sensing period, the interval between the time point at which the digital signal value of the pixel signal PXS is determined using the first ramp signal RAMP1 and the time at which the digital signal value of the pixel signal PXS is determined using the second ramp signal RAMP2 may be t511-t411.

The first ramp generating circuit 1010 may generate a first ramp signal RAMP1 having an offset h1 greater than the offset h0 and starting at the time t401. In this case, the first ramp signal RAMP1 may have the same value as the pixel signal PXS at the times t421 and t423. In addition, the second ramp generating circuit 1020 may generate a second ramp signal RAMP2 having an offset h2 smaller than the offset h0 and a reset signal starting at a time point t501. In this case, the second ramp signal RAMP2 may have the same value as the pixel signal PXS at the times t521 and t523. That is, in the first sensing period, the interval between a time at which the digital signal value of the pixel signal PXS is determined using the first ramp signal RAMP1 and a time at which the digital signal value of the pixel signal PXS is determined using the second ramp signal RAMP2 may be t421-t521. Also, in the second sensing period, the interval between a time at which the digital signal value of the pixel signal PXS is determined using the first ramp signal RAMP1 and a time at which the digital signal value of the pixel signal PXS is determined using the second ramp signal RAMP2 may be t423-t523.

Thus, according to embodiments, by starting the first ramp signal RAMP1 and the second ramp signal RAMP2 at different times and setting the offsets of the first ramp signal RAMP1 and the second ramp signal RAMP2 differently, the interval between the time at which the comparator (940 in FIG. 9) determines the value of the pixel signal PXS by using the first ramp signal RAMP1 and the time at which the comparator 940 determines the value of the pixel signal PXS by using the second ramp signal RMAP2 may increase further. Therefore, the influence of the current fluctuation that occurs when the comparator 940 determines the digital signal value of the pixel signal PXS by using the first ramp signal RAMP1 on the time of determining the digital signal value of the pixel signal PXS by using the second ramp signal RAMP2 may be reduced.

FIG. 14 shows that the first ramp signal RAMP1 has the larger offset than the second ramp signal RAMP2 and starts later than the second ramp signal RAMP2, but the present disclosure is not limited thereto. For example, according to embodiments, the timing controller 970 may generate the first ramp signal RAMP1 and the second ramp signal RAMP2 so that the first ramp generating circuit 1010 and the second ramp generating circuit 1020 further increase the interval between the time of determining the value of the pixel signal PXS by using the first ramp signal RAMP1 and the time of determining the value of the pixel signal PXS by using the second ramp signal RAMP2.

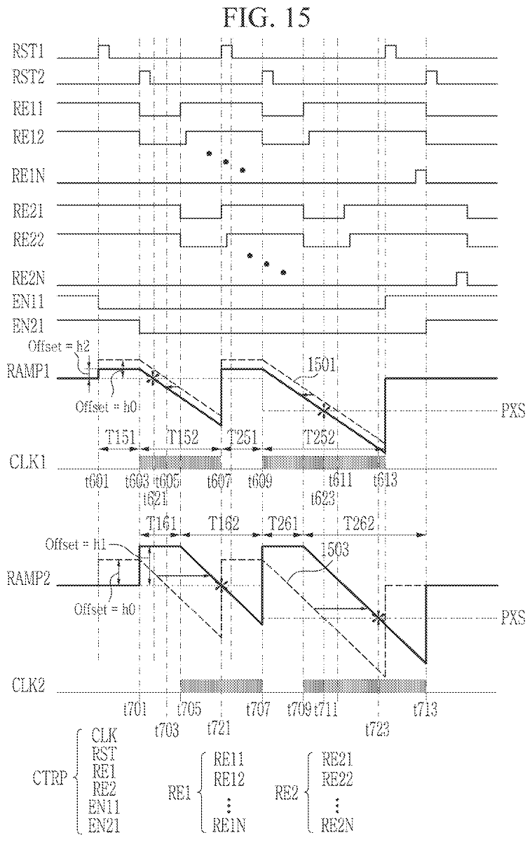

FIG. 15 is a timing diagram for explaining an operation of a ramp signal generator according to an embodiment. For convenience of explanation, a further description of the same or similar aspects as the timing diagram of the ramp signal generator in FIG. 14 is omitted.

During a first reset period T151 from a time t601 to a time to t603, the ramp circuit 1011 may generate the first ramp signal RAMP1 having a reset level voltage based on the first to N-th ramp activation signals RE11 to RE1N which is the logic low and the first emphasis activation signal EN11 which is the logic low.

During a first reset period T161 between a time t701 and a time t705 after the time t601, the ramp circuit 1021 may generate a second ramp signal RAMP2 having the reset level voltage based on the first to N-th ramp activation signals RE11 to RE1N of the logic low and the second emphasis activation signal EN21 of the logic low.

During the first reset period T151, the first ramp circuit 1011 may generate a first ramp signal RAMP1 having an offset voltage level based on the first to N-th ramp activation signals RE11 to RE1N of the logic low and the first emphasis activation signal EN11 of the logic low.

During the first reset period T161, the first ramp circuit 1021 may generate a second ramp signal RAMP2 having an offset voltage level based on the first to N-th ramp activation signals RE21 to RE2N of the logic low and the first emphasis activation signal EN21 of the logic low.

Thereafter, during the first sensing period T152 between the time point t603 and the time point t607, the first reset signal RST1 may be the logic low. In the first sensing period T152, if the first clock signal CLK1 is the logic high, at least one activation signal among the first to N-th ramp activation signals RE11 to RE1N may be the logic high. Then, as the first clock signal CLK1 toggles in the first sensing period T152, the number of the ramp activation signals RE11 to RE1N of the logic low may decrease.

In the first sensing period T162 between the time t705 and the time t707, the second reset signal RST2 may be the logic low. If the second clock signal CLK2 is the logic high from time t705 to t707, at least one activation signal among the first to N-th ramp activation signals RE21 to RE2N may become the logic high. Then, in the first sensing period T162, as the second clock signal CLK2 toggles, the number of the logic low ramp activation signals RE21 to RE2N may decrease.

During the first sensing period T152, the first ramp generating circuit 1010 may generate the first ramp signal RAMP1 based on the first to N-th ramp activation signals RE11 to RE1N and the first emphasis activation signal EN11.

During the first sensing period T162, the second ramp generating circuit 1020 may generate a second ramp signal RAMP2 based on the first to N-th ramp activation signals RE21 to RE2N and the second emphasis activation signal EN21.

Since the operation of the first ramp generating circuit 1010 from the time t607 to the time t613 is similar to the operation from the time t601 to the time t607, and the operation of the second ramp generating circuit 1020 from the time t707 to the time t713 is similar to the operation from the time t701 to the time t707, a detailed description thereof is omitted.

Referring to FIG. 15, when the reset signal starts at the time t601 with the offset h0, the first ramp signal is shown as a first graph 1501, and when the reset signal starts at the time t601 with the offset h0, the second ramp signal is shown as a second graph 1503. In this case, each of the first ramp generating circuit and the second ramp generating circuit may generate the first ramp signal RAMP1 and the second ramp signal RAMP2 based on the same reset signal. The first graph 1301 may have the same value as the pixel signal PXS at the time t605 and the time t611. The second graph 1303 may have the same value as the pixel signal PXS at the time t703 and the time t711. As shown in FIG. 15, the time t605 and the time t703 may be the same. In the second sensing period, the interval between the time at which the digital signal value of the pixel signal PXS is determined using the first ramp signal and the time at which the digital signal value of the pixel signal PXS is determined using the second ramp signal may be t611-t711.

The first ramp generating circuit 1010 may generate a first ramp signal RAMP1 having an offset h2 smaller than the offset h0 and starting at the time t601. In this case, the first ramp signal RAMP1 may have the same value as the pixel signal PXS at the time t621 and the time t623. In addition, the second ramp generating circuit 1020 may generate a second ramp signal RAMP2 having an offset h1 greater than the offset h0 and a reset signal starting at a time point t701. In this case, the second ramp signal RAMP2 may have the same value as the pixel signal PXS at the times t721 and t723. That is, in the first sensing period, the interval between the time at which the digital signal value of the pixel signal PXS is determined using the first ramp signal and the time at which the digital signal value of the pixel signal PXS is determined using the second ramp signal may be t721-t621. Also, in the second sensing period, the interval between the time at which the digital signal value of the pixel signal PXS is determined using the first ramp signal and the time at which the digital signal value of the pixel signal PXS is determined using the second ramp signal may be t723-t623.

Thus, according to embodiments, by starting the first ramp signal RAMP1 and the second ramp signal RAMP2 at different times and setting the offsets of the first ramp signal RAMP1 and the second ramp signal RAMP2 differently, the interval between the time at which the comparator (940 in FIG. 9) determines the value of the pixel signal PXS by using the first ramp signal RAMP1 and the time at which the comparator 940 determines the value of the pixel signal PXS by using the second ramp signal RMAP2 may increase further. Therefore, the influence of the current fluctuation that occurs when the comparator 940 determines the digital signal value of the pixel signal PXS by using the first ramp signal RAMP1 on the time of determining the digital signal value of the pixel signal PXS by using the second ramp signal RAMP2 may be reduced.

In FIG. 14, the time at which the digital signal value of the pixel signal PXS is determined using the first ramp signal RAMP1 having the large slope may be after the time at which the digital signal value of the pixel signal PXS is determined using the second ramp signal RAMP2 having the small slope. However, it may be difficult to significantly increase the interval between the time at which the first ramp signal RAMP1 determines the digital signal value and the time at which the second ramp signal RAMP2 determines the digital signal value depending on the slope values of the first ramp signal RAMP1 and the second ramp signal RAMP2.

On the other hand, in FIG. 15, the time at which the digital signal value of the pixel signal PXS is determined using the first ramp signal RAMP1 having the large slope may be before the time at which the digital signal value of the pixel signal PXS is determined using the second ramp signal RAMP2 having the small slope. Accordingly, regardless of the slope values of the first ramp signal RAMP1 and the second ramp signal RAMP2, the interval between the time when the first ramp signal RAMP1 determines the digital signal value and the time when the second ramp signal RAMP2 determines the digital signal value may be increased.

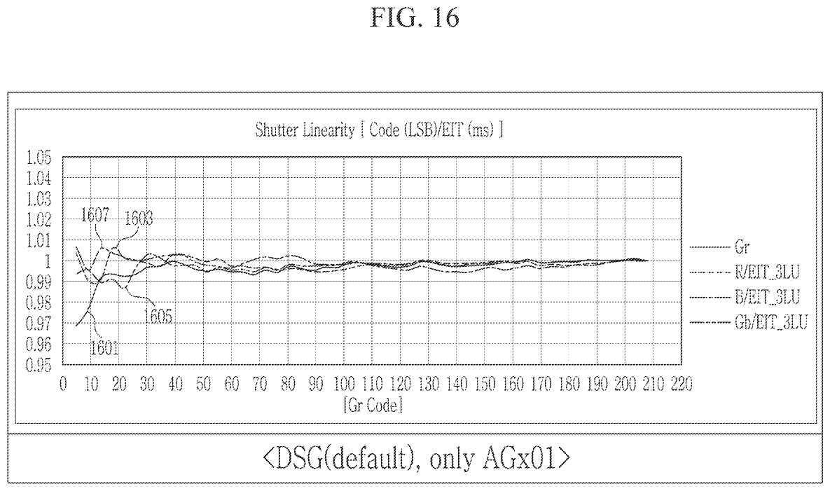

FIGS. 16 to 19 are graphs showing cases of reading a pixel signal using a ramp generating circuit according to an embodiment.

Referring to FIGS. 16 to 19, the x-axis is a code value representing an incident light, and the y-axis is a ratio of the code value of a sensed light to the code value of the incident light. In some embodiments, the code may be a gray code. For example, the code may indicate the number of photons, and the number of codes may increase as the amount of light increases. The code representing the sensed light relative to the code representing the incident light may read a more accurate pixel value as it has a value closer to 1.

FIG. 16 is a graph showing a ratio of output photons read with a first ramp signal for the number of input photons when reading a pixel signal by using a first ramp signal with a first analog gain AG*01 and a second ramp signal with a second analog gain AG*04.

The first graph 1601 shows the output of light having a green (Gr) component among the incident light, the second graph 1603 shows the output of light having a red®) component among the incident light, the third graph 1605 shows the output of light having a blue (B) component among the incident light, and the fourth graph 1607 shows the output of light having a green (Gb) component among the incident light. For example, in the first graph 1601, the second graph 1603, the third graph 1605, and the fourth graph 1607, when light having a value of 100 code or less is incident, the value of the output light may be smaller than that of the incident light.

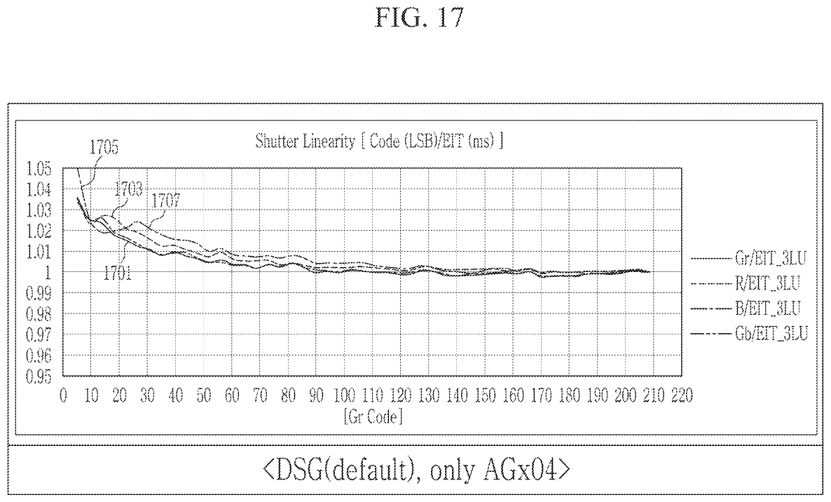

FIG. 17 is a graph showing a ratio of output photons read with a second ramp signal for the number of input photons when reading a pixel signal by using a first ramp signal with a first analog gain AG*01 and a second ramp signal with a second analog gain AG*04.

The first graph 1701 shows the output of light having a green (Gr) component among the incident light, the second graph 1703 shows the output of the light having a® (R) component among the incident lights, the third graph 1705 shows the output of light having a blue (B) component among the incident light, and the fourth graph 1707 shows the output of light having a green (Gb) component among the incident light. For example, in the first graph 1701, the second graph 1703, the third graph 1705, and the fourth graph 1707, when light having a value of 100 code or less is incident, the value of output light may be greater than that of incident light.

The operation of reading the pixel signal through the first ramp signal may affect the operation of reading the pixel signal through the second ramp signal. Accordingly, when the pixel signal is read through the second ramp signal, a difference between an actual pixel value and the read pixel value may be larger. For example, the first graph 1701 may have the larger difference from the actual pixel values than the first graph 1601.

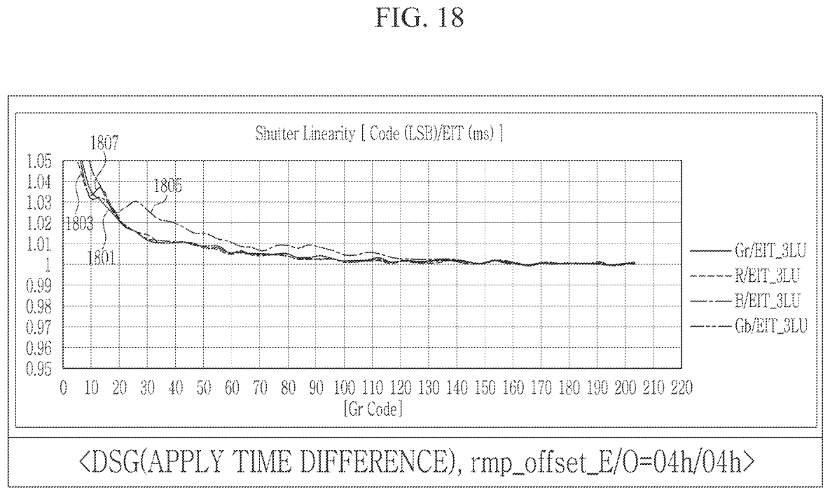

FIG. 18 is a graph showing a ratio of output photons read with a first ramp signal and a second ramp signal for the number of input photons when the first ramp signal having a first analog gain AG*01 and the second ramp signal having a second analog gain AG*04 are used, and a pixel signal is read with a time difference between the first ramp signal and the second ramp signal. The first ramp signal and the second ramp signal may have the same offset value.

The first graph 1801 shows the output of light having a green (Gr) component among the incident light, the second graph 1803 shows the output of light having a red (R) component among the incident light, the third graph 1805 shows the output of light having a blue (B) component among the incident light, and the fourth graph 1807 shows the output of light having a green (Gb) component among the incident light.

In the graph shown in FIG. 18, when the incident light has the code value of 100 or more, the code value of the incident light and the output code value may be almost the same. However, when the incident light has the code value of 90 or less, the difference between the code value of the incident light and the output code value may gradually increase.

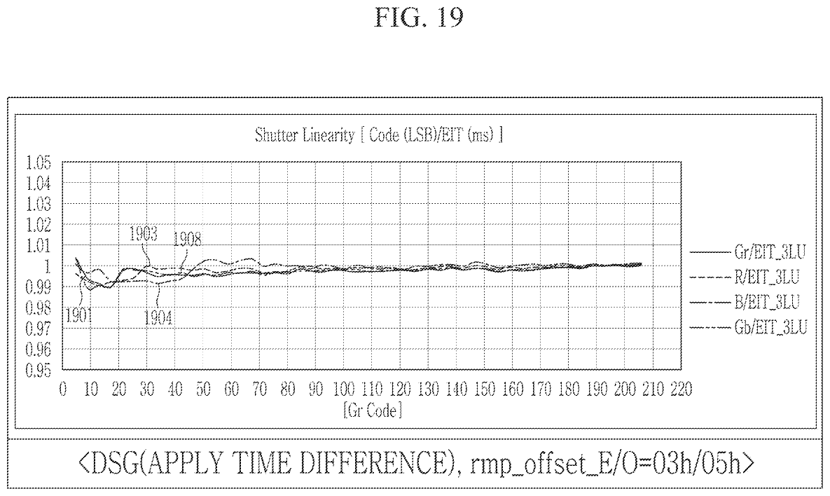

FIG. 19 is a graph showing a ratio of output photons read with a first ramp signal and a second ramp signal for the number of input photons when a first ramp signal having a first analog gain AG*01 and a second ramp signal having a second analog gain AG*04 are used, and a pixel signal is read with a time difference between the first ramp signal and the second ramp signal. The first ramp signal and the second ramp signal may have different offset values. For example, the first ramp signal may have the offset value of 05h, and the second ramp signal may have the offset value of 03h.

The first graph 1901 shows the output of light having a green (Gr) component among the incident light, the second graph 1903 shows the output of light having a red (R) component among the incident light, the third graph 1904 shows the output of light having a blue (B) component among incident light, and the fourth graph 1908 shows the output of light having a green (Gb) component among the incident light.

Referring to FIG. 19, since the code value of the incident light and the output code value are almost the same in all of the first graph 1901 to the fourth graph 1908, the ramp generating circuit may read the accurate pixel value through two ramp signals having the time differences and the different offsets.

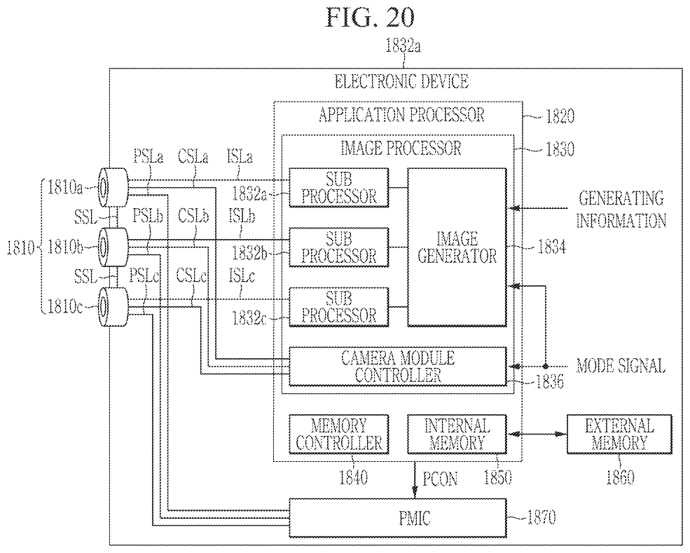

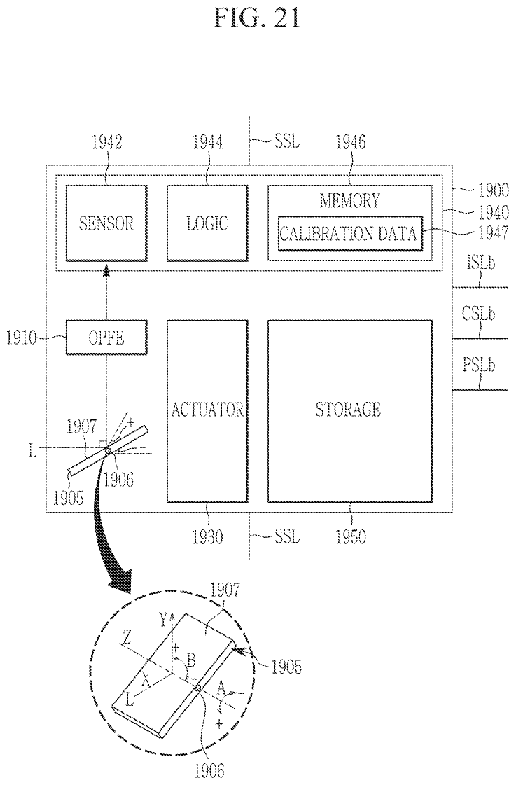

FIG. 20 is a block diagram of an electronic device having a multi-camera module including an image sensor according to an embodiment. FIG. 21 is a block diagram showing a camera module of FIG. 20 according to an embodiment.

Referring to FIG. 20, an electronic device 1800 may include a camera module group 1810, an application processor 1820, a power management integrated circuit (PMIC) 1870, and a storage 1860 (e.g., an external memory).

The camera module group 1810 may include a plurality of camera modules 1810a, 1810b, and 1810c. Although the drawing shows an embodiment in which three camera modules 1810a, 1810b, and 1810c are disposed, embodiments are not limited thereto. For example, in some embodiments, the camera module group 1810 may be modified to include only two camera modules. In some embodiments, the camera module group 1810 may be modified to include n (where, n is equal to 4 or more) camera modules.

Hereinafter, the configuration of the camera module 1810b will be described in more detail with reference to FIG. 19, but the following description may be equally applied to other camera modules 1810a and 1810c according to various embodiments.

Referring to FIG. 19, the camera module 1900 may include a prism 1905, an optical path folding element (hereinafter referred to as “OPFE”) 1910, an actuator 1930, an image sensing device 1940, and a storage unit 1950.

The prism 1905 may include a reflective surface 1907 of a light reflective material to transform a path of light L incident from outside of the electronic device 1800.

In some embodiments, the prism 1905 may change a path of light L incident in a first direction X to a second direction Y perpendicular to the first direction X. In addition, the prism 1905 rotates the reflective surface 1907 of the light reflective material in a direction A with the central axis 1906 as the center, or rotates the central axis 1906 in a direction B so that the path of the light L incident in the first direction X may be changed to the second direction Y, which is vertical. The OPFE 1910 may also move in a third direction (Z) vertical to the first direction X and the second direction Y.

In some embodiments, the maximum rotation angle of the direction A of the prism 1905 may be about 15 degrees or less in a positive (+) direction A and greater than about 15 degrees in a negative (−) direction A, but embodiments are not limited thereto.

In some embodiments, the prism 1905 may move about 20 degrees in a plus (+) or minus (−) direction B, or between about 10 degrees and about 20 degrees, or between about 15 degrees and about 20 degrees. The moving angle may be the same angle in the plus (+) or minus (−) direction B, or a substantially similar angle within a range of about 1 degree.

In some embodiments, the prism 1905 may move the reflective surface 1907 of the light reflective material in the third direction parallel to the elongation direction of the central axis 1906 (e.g., the Z direction).

The OPFE 1910 may include, for example, optical lenses including m (where m is a positive integer) number of groups. The m lenses may move in the second direction Y to change an optical zoom ratio of the camera module 1810b. For example, when a basic optical zoom ratio of the camera module 1810b is Z, if the m optical lenses included in the OPFE 1910 are moved, the optical zoom ratio of the camera module 1810b may be changed to an optical zoom ratio of 3Z or 5Z or higher. The OPFE 1910 may further include optical lenses including p (where p is a positive integer) number of groups on the front side of the m number of lenses described above.

The actuator 1930 may move the OPFE 1910 or an optical lens to a specific position. For example, the actuator 1930 may adjust the position of the optical lens so that the image sensor 1942 is positioned at the focal length of the optical lens for accurate sensing.

The image sensing device 1940 may include an image sensor 1942, a control logic 1944, and a memory 1946. The image sensor 1942 may sense an image of a sensing target by using a light L provided through the optical lens. In some embodiments, the image sensor 1942 may generate a plurality of ramp signals, compare the generated plurality of ramp signals with a pixel signal generated by the image of the sensing target, and convert the pixel signal into a digital signal. For example, the image sensor 1942 may generate a plurality of ramp signals operating with two different timings. As another example, the image sensor 1942 may generate a plurality of ramp signals having different offsets. The image sensor 1942 may increase a time interval between the times at which the pixel signals are read using each plurality of ramp signals. Accordingly, the image sensor 1942 may more accurately sense the image of the sensing target.

The control logic 1944 may control the overall operation of the camera module 1900. For example, the control logic 1944 may control the operation of the camera module 1900 according to a control signal provided through a control signal line CSLb.

The memory 1946 may store information utilized for the operation of the camera module 1900, such as a calibration data 1947. The calibration data 1947 may include information utilized for the camera module 1900 to generate image data by using a light L provided from outside of the electronic device 1800. The calibration data 1947 may include, for example, information about the degree of the rotation, information about the focal length, and information about an optical axis, which have been described above. When the camera module 1900 is implemented in the form of a multi-state camera of which the focal length changes according to the position of the optical lens, the calibration data 1947 may include information related to a focal length value and an auto focusing for each position (or a state) of the optical lens.

The storage unit 1950 may store the image data sensed through the image sensor 1942. The storage unit 1950 may be disposed outside of the image sensing device 1940 and may be implemented in the form stacked with a sensor chip constituting the image sensing device 1940. In some embodiments, the storage unit 1950 may be implemented as an electrically erasable programmable read-only memory (EEPROM), but embodiments are not limited thereto.

Referring to FIGS. 20 and 21 together, in some embodiments, a plurality of camera modules 1810a, 1810b, and 1810c may each include an actuator 1930. Accordingly, each of the plurality of camera modules 1810a, 1810b, and 1810c may include the same or different calibration data 1947 according to the operation of the actuator 1930 included therein.

In some embodiments, among the plurality of camera modules 1810a, 1810b, and 1810c, one camera module (e.g., 1810b) is a camera module in the form of a folded lens including the prism 1905 and the OPFE 1910 described above, and the remaining camera modules (e.g., 1810a, 1810b) may be vertical camera modules that do not include the prism 1905 and the OPFE 1910, but embodiments are not limited thereto.

In some embodiments, among the plurality of camera modules 1810a, 1810b, and 1810c, one camera module (e.g., 1810c) is a vertical-type depth camera that extracts depth information by using, for example, infrared (IR). In this case, the application processor 1820 may generate a 3D depth image by merging the image data provided from the depth camera and the image data provided from other camera modules (e.g., 1810a or 1810b).

In some embodiment, at least two camera modules (e.g., 1810a, 1810b) among the plurality of camera modules 1810a, 1810b, and 1810c may have different fields of view (viewing angles). In this case, the optical lenses of at least two camera modules (e.g., 1810a, 1810b) among, for example, the plurality of camera modules 1810a, 1810b, and 1810c may be different from each other, but are not limited thereto.

In some embodiments, the viewing angle of each of the plurality of camera modules 1810a, 1810b, and 1810c may be different from each other. In this case, the optical lens included in each of the plurality of camera modules 1810a, 1810b, and 1810c may also be different from each other, but are not limited thereto.

In some embodiments, each of the plurality of camera modules 1810a, 1810b, and 1810c may be physically separated from each other and disposed. That is, the sensing region of one image sensor 1942 is not divided and used by the plurality of camera modules 1810a, 1810b, and 1810c, but an independent image sensor 1942 may be disposed inside each plurality of camera modules 1810a, 1810b, and 1810c.

Referring again to FIG. 20, the application processor 1820 may include an image processing device 1830, a memory controller 1840, and an internal memory 1850. The application processor 1820 may be implemented separately from the plurality of camera modules 1810a, 1810b, and 1810c. For example, the application processor 1820 and the plurality of camera modules 1810a, 1810b, and 1810c may be separately implemented as separate semiconductor chips.

The image processing device 1830 may include a plurality of sub-image processors 1832a, 1832b, and 1832c, an image generator 1834, and a camera module controller 1836.

The image processing device 1830 may include a plurality of sub-image

processors 1832a, 1832b, and 1832c corresponding to the number of the plurality of camera modules 1810a, 1810b, and 1810c.

The image data generated from each of the camera modules 1810a, 1810b, and 1810c may be provided to corresponding sub-image processors 1832a, 1832b, and 1832c through separate image signal lines ISLa, ISLb, and ISLc. For example, the image data generated from the camera module 1810a may be provided to the sub-image processor 1832a through the image signal line ISLa, the image data generated from the camera module 1810b may be provided to the sub-image processor 1832b through the image signal line ISLb, and the image data generated from the camera module 1810c may be provided to the sub-image processor 1832c through the image signal line ISLc. Such image data transmission may be performed using, for example, a camera serial interface (CS1) based on Mobile Industry Processor Interface (MIPI), but embodiments are not limited thereto.

The image data provided to each of the sub-image processors 1832a, 1832b, and 1832c may be provided to the image generator 1834. The image generator 1834 may generate an output image by using the image data provided from each of the sub-image processors 1832a, 1832b, and 1832c according to an image generation information or a mode signal.

For example, the image generator 1834 may generate the output image by merging at least some of the image data generated from the camera modules 1810a, 1810b, and 1810c having the different viewing angles according to the image generation information or the mode signals. In addition, the image generator 1834 may generate the output image by selecting one of the image data generated from the camera modules 1810a, 1810b, and 1810c having the different viewing angles according to the image generation information or the mode signals.

The camera module controller 1836 may provide the control signal to each of the camera modules 1810a, 1810b, and 1810c. The control signals generated from the camera module controller 1836 may be provided to the corresponding camera modules 1810a, 1810b, and 1810c through the control signal lines CSLa, CSLb, and CSLc separated from each other.

The application processor 1820 may store the received image signal, that is, the encoded image signal, in the memory provided inside the memory 1830 or the storage 1860 outside the application processor 1820, and then, read and decode the encoded image signal from the memory 1830 or the storage 1860, and display the image data generated based on the decoded image signal. For example, a corresponding sub-image processor among the plurality of sub-image processors 1832a, 1832b, and 1832c of the image processing device 1830 may perform the decoding and may also perform image processing on the decoded image signal.

The PMIC 1870 may supply power, for example, a power source voltage to each of the plurality of camera modules 1810a, 1810b, and 1810c. For example, the PMIC 1870 may supply first power to the camera module 1810a through a power signal line PSLa under the control of the application processor 1820, supply second power to the camera module 1810b through a power signal line PSLb, and supply third power to the camera module 1810c through a power signal line PSLc.

In some embodiments, each component or combinations of two or more components described with reference to FIGS. 1 to 19 may be implemented as a digital circuit, a programmable or non-programmable logic device or array, an application specific integrated circuit (ASIC), or the like.

As is traditional in the field of the present disclosure, embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, etc., which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions.

While the present disclosure has been particularly shown and described with reference to embodiments thereof, it will be understood by those of ordinary skill in the art that various changes in form and detail may be made therein without departing from the spirit and scope of the present disclosure as defined by the following claims.

What is claimed is:

1. An image sensor, comprising:
a pixel array including a plurality of pixels configured to output a pixel signal;
a ramp signal generator circuit configured to generate a first ramp signal and a second ramp signal,
wherein a first offset voltage level of the first ramp signal rises or falls with a first slope and a second offset voltage level of a second ramp signal rises or falls with a second slope different from the first slope,
wherein a starting time at which the first ramp signal rises or falls with the first slope and a starting time at which the second ramp signal rises or falls with the second slope are different; and
an analog-to-digital converter circuit configured to generate an image signal based on a first comparison result obtained by comparing the pixel signal and the first ramp signal and a second comparison result obtained by comparing the pixel signal and the second ramp signal.

2. The image sensor of claim 1, further comprising:
a timing controller circuit configured to generate a first ramp control signal that controls the ramp signal generator circuit to generate the first ramp signal and a second ramp control signal that controls the ramp signal generator circuit to generate the second ramp signal.

3. The image sensor of claim 2, wherein
the first ramp control signal includes a first ramp reset signal that controls the starting time of the first ramp signal, and the second ramp control signal includes a second ramp reset signal that controls the starting time of the second ramp signal, and
the first ramp reset signal is enabled at a different time than the second ramp reset signal.

4. The image sensor of claim 3, wherein
the first slope is greater than the second slope, the first ramp reset signal is enabled at a first time, and the second ramp reset signal is enabled at a second time after the first time.

5. The image sensor of claim 2, wherein
the first ramp control signal includes a first emphasis activation signal that controls the first offset voltage level, and the second ramp control signal includes a second emphasis activation signal that controls the second offset voltage level,
the ramp signal generator circuit includes a first emphasis circuit that operates based on the first emphasis activation signal, and a second emphasis circuit that operates based on the second emphasis activation signal, and
the first offset voltage level is different from the second offset voltage level.

6. The image sensor of claim 5, wherein
the first slope is greater than the second slope, and the first offset voltage level is less than the second offset voltage level.

7. The image sensor of claim 5, wherein
the first emphasis circuit includes a plurality of first emphasis current sources that operate in response to the first emphasis activation signal, and the second emphasis circuit includes a plurality of second emphasis current sources that operate in response to the second emphasis activation signal.

8. The image sensor of claim 5, wherein
the first ramp control signal includes a first ramp activation signal that controls the first slope, and the second ramp control signal includes a second ramp activation signal that controls the second slope, and
the ramp signal generator circuit further includes a first ramp circuit that operates based on the first ramp activation signal, and a second ramp circuit that operates based on the second ramp activation signal.

9. The image sensor of claim 8, wherein
the first ramp circuit includes a plurality of first current sources operating in response to the first ramp activation signal, and the second ramp circuit includes a plurality of second current sources operating in response to the second ramp activation signal.

10. The image sensor of claim 2, wherein
the first ramp control signal includes a first ramp reset signal that controls the starting time of the first ramp signal and a first emphasis activation signal that controls the first offset voltage level of the first ramp signal,
the second ramp control signal includes a second ramp reset signal that controls the starting time of the second ramp signal and a second emphasis activation signal that controls the second offset voltage level of the second ramp signal,
the ramp signal generator circuit includes a first emphasis circuit that operates based on the first emphasis activation signal, and a second emphasis circuit that operates based on the second emphasis activation signal, and
the first ramp reset signal is enabled at a time different from that of the second ramp reset signal, and the first offset voltage level of the first ramp signal is different from the second offset voltage level of the second ramp signal.

11. The image sensor of claim 1, wherein
the analog-to-digital converter circuit includes a first comparator that generates the first comparison result by comparing the pixel signal and the first ramp signal, and a second comparator that generates the second comparison result by comparing the pixel signal and the second ramp signal, and
a first time at which the pixel signal and the first ramp signal have a same value is different from a second time at which the pixel signal and the second ramp signal have a same value.

12. An operation method of an image sensor, comprising:
outputting a pixel signal from a pixel array including a plurality of pixels;
generating a first ramp signal having a first slope at a first time based on a first ramp reset signal;
generating a second ramp signal having a second slope different from the first slope at a second time different from the first time based on a second ramp reset signal; and
generating an image signal based on a first comparison result obtained by comparing the pixel signal and the first ramp signal, and a second comparison result obtained by comparing the pixel signal and the second ramp signal.

13. The operation method of the image sensor of claim 12, wherein
generating the first ramp signal includes generating the first ramp signal having a first offset voltage level based on a first emphasis activation signal, and
generating the second ramp signal includes generating the second ramp signal having a second offset voltage level different from the first offset voltage level based on a second emphasis activation signal.

14. The operation method of the image sensor of claim 13, wherein
generating the second ramp signal includes generating the second ramp signal having the second offset voltage level greater than the first slope and less than the first offset voltage level.

15. The operation method of the image sensor of claim 12, wherein
generating the first ramp signal includes controlling a plurality of first current sources to have the first slope based on a first ramp activation signal, and
generating the second ramp signal includes controlling a plurality of second current sources to have the second slope based on a second ramp activation signal.

16. An image sensor, comprising:
a pixel array including a plurality of pixels configured to output pixel signal;
a first comparator connected to the pixel array and configured to generate a first comparison result obtained by comparing the pixel signal with a first ramp signal that rises or falls with a first slope;
a second comparator connected to the pixel array and configured to generate a second comparison result obtained by comparing the pixel signal with a second ramp signal that rises or falls with a second slope different from the first slope;
a first counter circuit connected to the first comparator and configured to count the first comparison result based on a first clock signal; and
a second counter circuit connected to the second comparator and configured to count the second comparison result based on a second clock signal different from the first clock signal,
wherein the first counter circuit and the second counter circuit start counting at different times.

17. The image sensor of claim 16, wherein
the first counter circuit generates a first digital signal by counting the first comparison result, and the second counter circuit generates a second digital signal by counting the second comparison result, and
the image sensor further comprises:
a timing controller circuit configured to generate a first ramp control signal that generates the first ramp signal and a second ramp control signal that generates the second ramp signal based on the first digital signal and the second digital signal.

18. The image sensor of claim 17, further comprising:
a ramp signal generator circuit configured to generate the first ramp signal and the second ramp signal based on the first ramp control signal and the second ramp control signal.

19. The image sensor of claim 17, wherein
the first ramp control signal controls a starting time and an offset voltage level of the first ramp signal, and the second ramp control signal controls a starting time and an offset voltage level of the second ramp signal.

20. The image sensor of claim 16, wherein
the first comparator and the second comparator share a power source voltage and a ground voltage.
